(19) United States
(12) Patent Application Publication
(10) Pub. No.: US 2026/0147160 A1
(43) Pub. Date: May 28, 2026

(54) OPTICAL DEVICE, OPTICAL ASSEMBLY, AND METHOD OF FORMING OPTICAL ASSEMBLY

(71) Applicant: BROWAVE CORPORATION, HSINCHU COUNTY (TW)

(72) Inventor: Yoyou HSU, HSINCHU CITY (TW)

(21) Appl. No.: 19/456,568

(22) Filed: Jan. 22, 2026

Related U.S. Application Data
(63) Continuation-in-part of application No. 18/672,322, filed on May 23, 2024.
(60) Provisional application No. 63/513,015, filed on Jul. 11, 2023.
(60) Provisional application No. 63/598,252, filed on Nov. 13, 2023.

(51) Int. Cl. G02B 6/32; G02B 6/26; G02B 6/38

(52) U.S. Cl. CPC G02B 6/32; G02B 6/262; G02B 6/3885

(57) ABSTRACT

The present disclosure provides an optical device including a collimator array, a receptacle housing, and an anti-slip collar. The collimator array includes a fiber array and a collimator lens array. The fiber array includes fibers and a plate holder. The collimator lens array is fixated to the fiber array by a first adhesive and optically coupled to the fibers. The receptacle housing is fixated to the collimator array in part by a second adhesive, and includes a pin hole running through the receptacle housing. The pin hole is configured to receive a detachable coupling means of a corresponding plug housing external to the optical device, so as to mechanically couple the plug housing to the receptacle housing. The anti-slip collar is attached at the receptacle housing and configured to accommodate the detachable coupling means and provide a friction to the detachable coupling means.

### CROSS-REFERENCE TO RELATED APPLICATION

The present application is a continuation-in-part application of U.S. patent application Ser. No. 18/672,322, filed on May 23, 2024, which claims priority to U.S. Provisional Patent Application No. 63/513,015 , filed on Jul. 11, 2023 and U.S. Provisional Patent Application No. 63/598,252 , filed on Nov. 13, 2023. All of the above-referenced applications are hereby incorporated herein by reference in their entireties.

### FIELD

The present disclosure relates to an optical device, an optical assembly, and a method of forming the optical assembly, particularly, to an optical device having a detachable coupling means allowing a quick and precision assembly with a photonic integrated circuit (PIC).

### BACKGROUND

Optical device is facing the trend of scaling down and more compact packaging as the electronic device. Limitation and principles of optical devices are different from those of electronic device, and hence the pace of miniaturization of the electronic devices can be faster than that of the optical devices. Co-packaged optics (CPO) is one of the fields that require compact integration of optical devices and electronic devices. To harmonize the scaling trend of the electronic devices and the optical devices, a more compact design for optical devices has to be provided. Components in optical devices, such as fibers and waveguides, are with a given dimension in view of the operating wavelength. Alignment between optical components generate unavoidable error according to the principle of optics. New and optimized designs for optical devices to be integrated in the CPO are therefore in need to advance the technology.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optoelectronic system according to some embodiments of the present disclosure.

FIG. 2 is a schematic diagram of a co-packaged optics according to some embodiments of the present disclosure.

FIG. 3 is a schematic diagram of an optical assembly according to some embodiments of the present disclosure.

FIG. 4 is a schematic diagram of an optical device viewing from a Y-Z plane according to some embodiments of the present disclosure.

FIG. 5 is a schematic diagram of an optical device viewing from a Y-Z plane according to some embodiments of the present disclosure.

FIG. 6 is a schematic diagram of a photonic integrated circuit (PIC) assembly with surface coupling feature according to some embodiments of the present disclosure.

FIG. 7A and FIG. 7B are schematic diagrams of prism-type lenses to be implemented in the PIC assembly of FIG. 6 according to some embodiments of the present disclosure.

FIG. 8 is a schematic diagram of a PIC array with multi-row lens array according to some embodiments of the present disclosure.

FIG. 9, FIG. 10A, FIG. 10B, FIG. 11A, FIG. 11B, FIG. 12, FIG. 13A, FIG. 13B, and FIG. 13C are schematic diagrams of intermediate stages of a method of forming an optical assembly according to some embodiments of the present disclosure.

FIG. 14 is a schematic diagram of an optical assembly according to some embodiments of the present disclosure.

FIG. 15A and FIG. 15B are schematic diagrams of a plug housing, a detachable coupling means, a receptacle housing, and a receiving portion viewing from an X-Z plane according to some embodiments of the present disclosure.

FIG. 16 is a schematic diagram of a plug housing according to some embodiments of the present disclosure.

FIG. 17A and FIG. 17B are schematic diagrams of an optical device and an optical component viewing from a Y-Z plane according to some embodiments of the present disclosure.

FIG. 18 is a schematic diagram of an optical assembly according to some embodiments of the present disclosure.

FIG. 19A and FIG. 19B are schematic diagrams of an optical device and an optical component viewing from a Y-Z plane according to some embodiments of the present disclosure.

FIG. 20A, FIG. 20B, and FIG. 20C are schematic diagrams of an optical device according to some embodiments of the present disclosure.

FIG. 21A and FIG. 21B are schematic diagrams of an anti-slip collar according to some embodiments of the present disclosure.

FIG. 22 is a schematic diagram of an optical component according to some embodiments of the present disclosure.

FIG. 23 is a schematic diagram of an optical assembly according to some embodiments of the present disclosure.

FIG. 24A and FIG. 24B are schematic diagrams of an optical device according to some embodiments of the present disclosure.

FIG. 25 is a schematic diagram of a PIC array according to some embodiments of the present disclosure.

FIG. 26 is a schematic diagram of an optical assembly according to some embodiments of the present disclosure.

FIG. 27A and FIG. 27B are schematic diagrams of an optical device according to some embodiments of the present disclosure.

FIG. 28, FIG. 29A, FIG. 29B, FIG. 29C, FIG. 30, and FIG. 31 are schematic diagrams of intermediate stages of a method of forming an optical assembly according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the respective testing measurements. Also, as used herein, the terms “substantially,” “approximately,” or “about” generally means within a value or range which can be contemplated by people having ordinary skill in the art. Alternatively, the terms “substantially,” “approximately,” or “about” means within an acceptable standard error of the mean when considered by one of ordinary skill in the art. People having ordinary skill in the art can understand that the acceptable standard error may vary according to different technologies. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “substantially,” “approximately,” or “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

A photonic integrated circuit (PIC) uses a light source (e.g., a laser) to input light that drives the components, similar to turning on a switch to inject electricity that drives electronic components. In a PIC, photons pass through optical components such as waveguides, lasers, polarizers, and phase shifters. An electrical integrated circuit (EIC) is an assembly of electronic components in which hundreds to millions of transistors, resistors, and capacitors are interconnected and built up on a semiconductor substrate. When EIC and PIC are integrated using, for example, silicon photonics technology, at least one built-in optoelectronic (E/O) module which converts an electrical signal to an optical signal, and vice versa, may present for subsequent data processing.

Co-Packaged Optics (CPO) is an advanced heterogeneous integration of PICs and EICs on a single packaged substrate aimed at addressing next generation bandwidth and power challenges. CPO brings together a wide range of expertise in fiber optics, digital signal processing (DSP), switch ASICs, and state-of-the-art packaging and test to provide a system-level value for the data center and cloud infrastructure. The present disclosure provides an optical device configured to detachably couple with a PIC, an optical assembly including the optical device and the PIC, and a method of forming the optical assembly that provide a compact arrangement of a plurality of PICs co-packaged with the EIC so as to obtain a CPO platform capable of sustaining rapid data growth and supporting high-bandwidth applications.

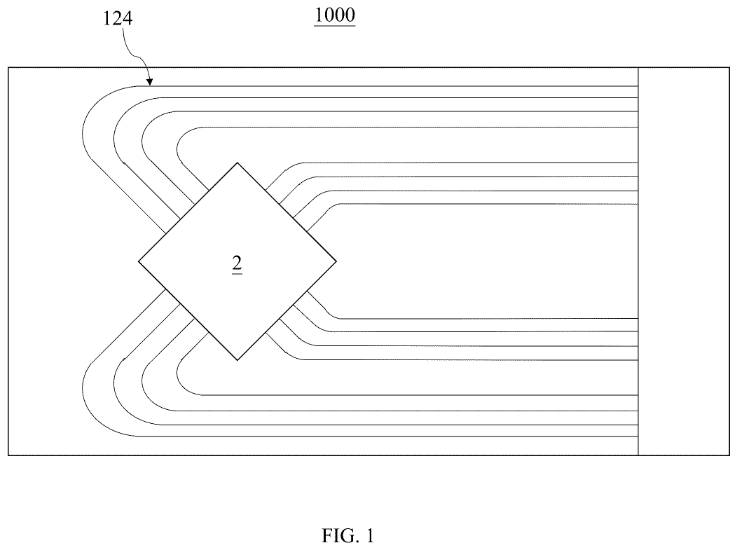

FIG. 1 is a schematic diagram of an optoelectronic system 1000 according to some embodiments of the present disclosure. The optoelectronic system 1000 includes a CPO 2 connected with optical fibers or fibers 124 referred herein. The optoelectronic system 1000 is configured to transmit/receive signals through the fibers to/from external device. The number of fibers 124 shown in FIG. 1 is provided for illustrated purposes. Various number of fibers 124 in the optoelectronic system 100 are within the contemplated scope of the present disclosure. Generally speaking, more fibers 124 in an optoelectronic system 1000 can provide higher density of signal transmission as well as the higher performance of the optoelectronic system 1000. For each of the fibers 124, one end of which is in connection with an optical module of the CPO 2, and the opposite end of which is in connection with a light source (not illustrated) such as a laser with suitable wavelength.

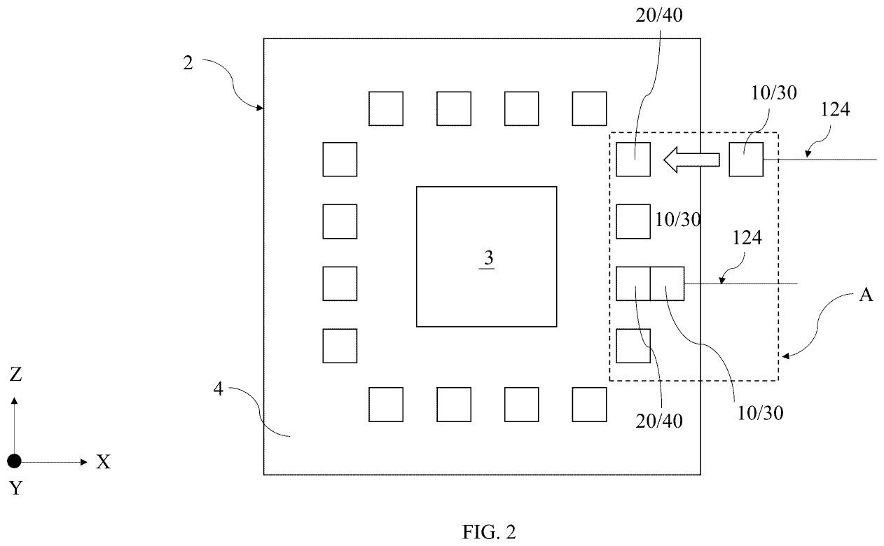

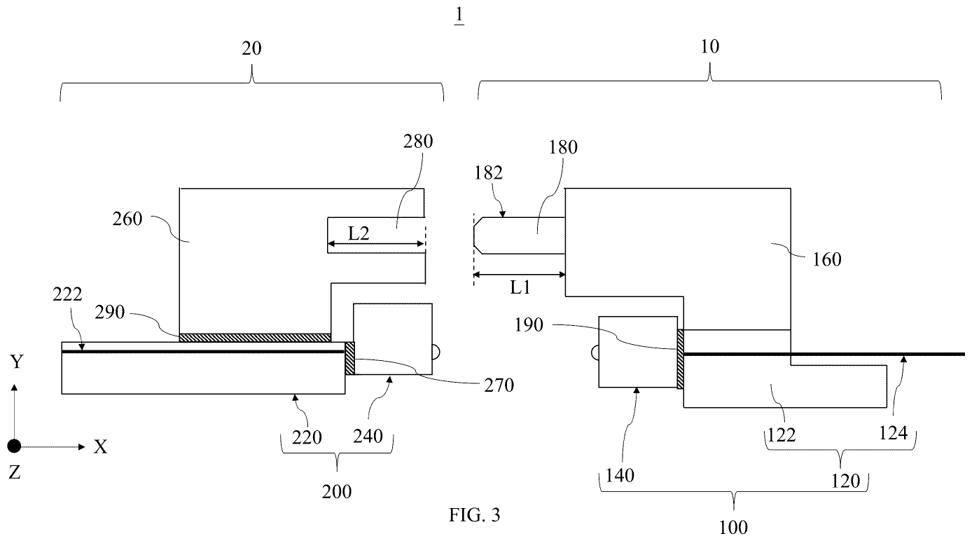

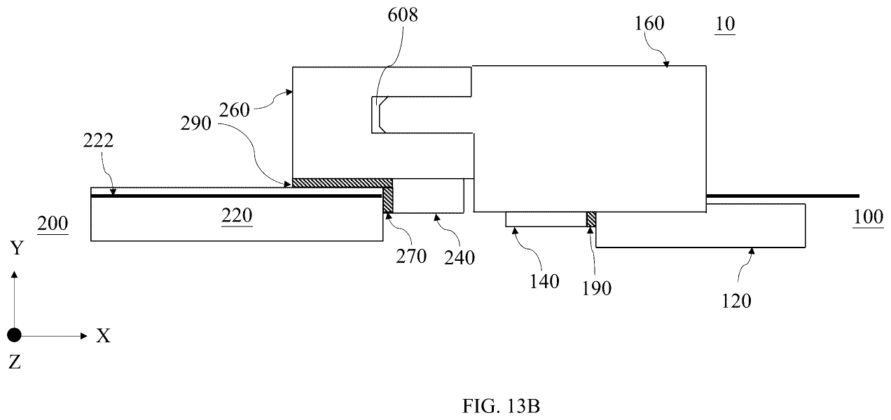

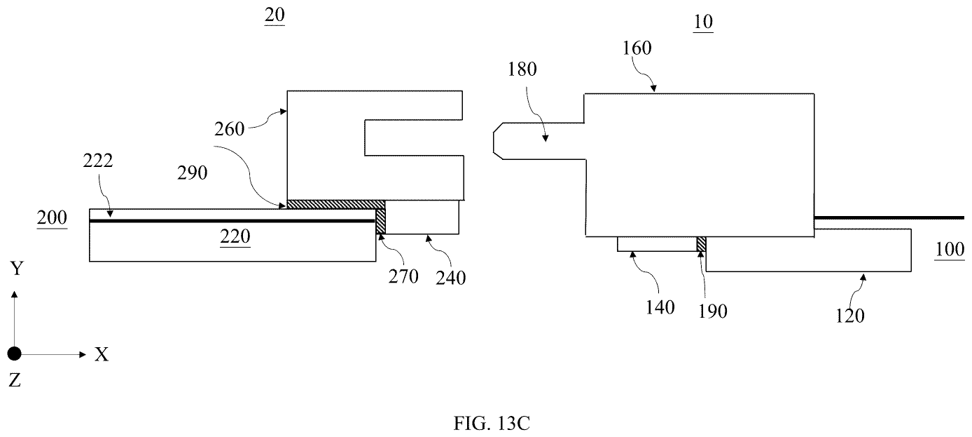

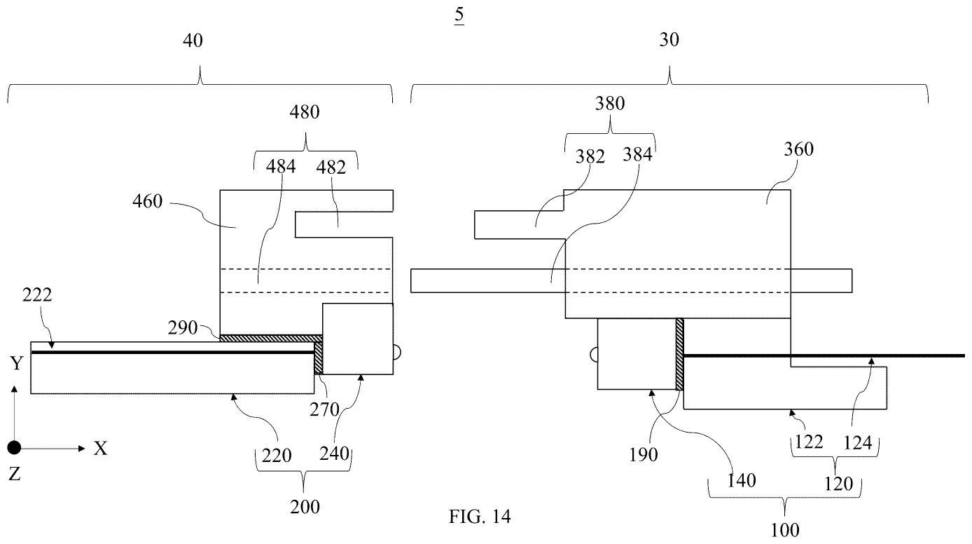

FIG. 2 is a schematic diagram of the CPO 2 according to some embodiments of the present disclosure. The CPO 2 includes an EIC 3, or a so-called switch IC, and a plurality of optical components 20/40 (detailed in FIG. 3 and FIG. 14) surrounding the EIC 3 on a surface of a substrate 4 (e.g., a printed circuit board). Each of the optical components 20/40 is electrically connected to the EIC 3 at least via the conductive wiring structure of the substrate 4, and detachably connected to an optical device 10/30 (detailed in FIG. 3 and FIG. 14) which can be removed when not in use or when replacement is needed. When the optical device 10/30 and the optical component 20/40 are connected, a light signal from a desired light source is transmitted to the optical component 20/40 through the optical device 10/30, and the combination of the optical component 20/40 and the optical device 10/30 is referred to an optical assembly herein, or a so-called CPO optical module. When the optical device 10/30 and the optical component 20/40 are disconnected, or detached from each other, no light signal is injecting into the optical component 20/40. Since it is a frequent operation to attach and detach the optical device 10/30 to/from the optical component 20/40 on the substrate 4, a detachable coupling mechanism which provides a reliable light coupling effect between the optical device 10/30 and the optical component 20/40 is crucial.

Note that a symbolic single fiber 124 illustrated in FIG. 2 is for demonstrative purpose, a plurality of fibers 124 such as a fiber array or multi-row fiber array can be implemented as needed. 20 channels or 24 channels of fiber array can be considered. For example, a 24 channels fiber array including 8 transmitter channels, 8 receiver channels, and 8 external laser source channels can be used. In some embodiments, a fiber pitch in a same row of the optical device 10/30 can be 127 μm or 250 μm, and a row pitch in the multi-row fiber array arrangement can at least be 250 μm.

FIG. 3 is a schematic diagram of an optical assembly 1 according to some embodiments of the present disclosure. The optical assembly 1 includes the optical device 10 and the optical component 20. The optical device 10 can be a collimator array with a plug mechanism, as opposed to the optical component 20 which can be a PIC with a receptacle mechanism, where the plug mechanism can detachably couple to the receptacle mechanism and provide a reliable light coupling effect. The optical device 10 includes a collimator array 100 which combines a fiber array 120 and a collimator lens array 140, a plug housing 160 fixed to the collimator array 100, and a detachable coupling means 180 at a side surface of the plug housing 160, extending away from the fibers 124 of the fiber array 120. The optical component 20 includes a PIC array 200 which combines a PIC 220 and a PIC lens array 240, a receptacle housing 260, and a receiving portion 280 recessed from a side of the receptacle housing 260. The optical device 10 and the optical component 20 are optically coupled through the detachably coupling of the plug mechanism and the receptacle mechanism, for example, through the detachable coupling means 180 protruding from a side of the plug housing 160 and the receiving portion 280 recessed from the side of the receptacle housing 260.

Referring to the optical device 10 of the optical assembly 1, an adhesive 190 is properly located to fixate the collimator lens array 140 and the fiber array 120. In some embodiments, the adhesive 190 can be a curable glue layer. Prior to the glue layer being cured and solidified, the glue layer is deformable and allows the fiber array 120 and the collimator lens array 140 to adjust individually of their corresponding positions during an alignment operation. After alignment and optical coupling efficiency between the fiber array 120 and the collimator lens array 140 are optimized, the glue layer can subsequently undergo curing operations to obtain a permanent fixation position.

The fiber array 120 includes a plate holder 122 holding the fibers 124. In some embodiments, each of the fibers 124 has a longitudinal direction along an X-direction. In some embodiments, the plurality of fibers 124 are arranged traversing the Z-direction. After the aforementioned alignment between the fiber array 120 and the collimator lens array 140, each of the fibers 124 is optically coupled to the corresponding lens of the collimator lens array 140.

In order to increase the alignment tolerance between the optical device 10 and the optical component 20, the collimator lens array 140 at its data transmitting interface includes a lens array, or the collimator lens array 140 referred herein, in conjunction with the fibers 124 thereby enlarging the beam size of the light signal during the transmitting phase from different optical parts, for example, from the optical device 10 to the optical component 20. For example, the beam size exiting the collimator lens array 140 may be greater than a core size of the respective fibers 124.

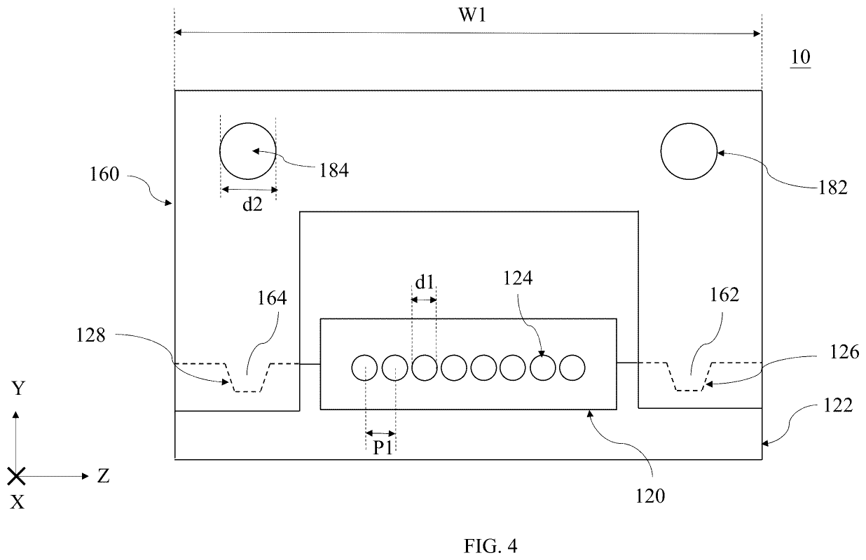

As shown in FIG. 3, the plug housing 160 is fixated to a top surface of the plate holder 122 of the collimator array 100. In some embodiments, different from that the receptacle housing 260 being fixated to the PIC 220 through an adhesive 290, the plug housing 160 may be fixated to the plate holder 122 in part by an engagement mechanism which includes a protrusion fitted against a recess on the top surface of the plate holder 122. Details of the engagement mechanism between the plug housing 160 and the plate holder 122 can be referred to FIG. 4 of the present disclosure.

Referring to FIG. 3, the detachable coupling means 180 is disposed at a side surface of the plug housing 160 and configured to mechanically couple the plug housing 160 to the optical component 20 through the receptacle housing 260. In some embodiments, the detachable coupling means 180 includes a pin 182 protruding from the side surface of the plug housing 160 and extending along the X-direction. In some embodiments, the plug housing 160 has a pin hole, and the pin 182 traverses the body of the plug housing 160 through the pin hole. In other embodiments, the detachable coupling means 180 and plug housing 160 are a monolithic structure made of the same material. In some embodiments, the plug housing 160 and/or the detachable coupling means 180 are composed of Polyetherimide (PEI) polymeric material, e.g., Ultem® PEI, which delivers a superior machinable precision.

The PIC array 200 includes a PIC 220 and a PIC lens array 240 coupled to the PIC 220. The PIC 220 may include various optical elements such as waveguides, lasers, polarizers, and phase shifter or redistribution structure, for the purpose of brevity, only waveguides 222 are illustrated in the PIC 220. The PIC lens array 240 is fixated to the PIC 220 by an adhesive 270, and optically coupled to the waveguides 222. In some embodiments, the adhesive 270 is similar to the adhesive 190 as previously described in optical device 10, and the formation of the adhesive 270 is substantially the same as the formation of the adhesive 190. The PIC lens array 240 of the optical component 20 is configured to optically align with the collimator lens array 140 of the optical device 10.

Similarly, in order to increase the alignment tolerance between the optical device 10 and the optical component 20, the PIC array 200 at its data transmitting interface includes a lens array, or the PIC lens array 240 referred herein, in proximity to the collimator lens array 140 thereby receiving the light at a greater beam size outputted from the collimator lens array 140 and subsequently, inputted into the waveguides 222 with a more confined beam size. The other way around, the beam size of an input light exiting the PIC lens array 220 is greater than a core size of the waveguide 222 in conjunction thereto.

The receptacle housing 260 is fixated to the PIC array 200 by an adhesive 290. In some embodiments, adhesive 290 is similar to the adhesive 190, and the formation of the adhesive 290 is substantially the same as the formation of the adhesive 190. The receiving portion 280 of the receptacle housing 260 is disposed at a side surface of the receptacle housing 260 and configured to mechanically couple the receptacle housing 260 to the plug housing 160 through the detachable coupling means 180.

In some embodiments, the receiving portion 280 is a recess structure at the side surface of the receptacle housing 260 with corresponding shape and dimension to accommodate the detachable coupling means 180 of the optical device 10. For example, the detachable coupling means 180 such as a pin 182 has a length L1 measured from the side surface of the plug housing 160 to a tip of the pin 182, and the receiving portion 280 has a length L2 measured from a distal inner sidewall to the side surface of the receptacle housing 260. In some embodiments, the length L1 is less than the length L2 so as to prevent the dimensional difference within machinable tolerance of the detachable coupling means 180 from gaping the receptacle housing 260 and the plug housing 160 when detachably coupled. In other words, when the pin 182 is plugged in the receiving portion 280, the tip of the pin 182 does not touch the distal inner sidewall of the receiving portion 280.

Referring to FIG. 3, the design of the collimator lens array 140 and the PIC lens array 240 are aimed for less than 0.3 dB connection loss. Alternatively stated, when the connection tolerance XY, measured as X μm and Y degree and XY being less than 1.1, the aforesaid less than 0.3 dB connection loss can be achieved. Under the present setting of the plug housing 160 and the receptacle housing 260, one of the limiting factors for the connection tolerance XY is the machinable precision of the plug housing 160 and the receptacle housing 260, on top of the collimator lens array 140 and the PIC lens array 240. By using the plastic injection technique with Polyetherimide (PEI) polymeric material, e.g., Ultem® PEI, less than 5 μm and about 0.2 degree can be achieved and matching the connection tolerance XY.

FIG. 4 is a schematic diagram of the optical device 10 from a viewing from a Y-Z plane according to some embodiments of the present disclosure. As illustrated in FIG. 4, at least a pin 182 or 184 is protruded from the side of the plug housing 160. The plug housing 160 is fixated to the collimator array 100 in part by engagement of a strip protrusion 162 and/or a strip protrusion 164 at a bottom surface of the plug housing 160 to a groove 126 and/or a groove 128 on the top surface of the plate holder 122, respectively. In some embodiments, the strip protrusion 162/164 and the groove 126/128 are parallel along a longitudinal direction of the plurality of fibers 124, as illustrated in FIG. 3. From the perspective viewing from the Y-Z plane, the collimator lens array 120 carrying a plurality of fibers 124 is disposed between the groove 126 and the groove 128 located at two opposite sides of the plate holder 122.

Referring to FIG. 4, in some embodiments, a width W1 of the optical device 10 along the Z-direction is between about 5 mm to about 6 mm, with a diameter d1 of the fiber 124 being about 0.125 mm, a pitch P1 of the fibers 124 on the same row being about 0.127 mm, and a diameter d2 of the pin 182/184 being about 0.6 mm. In some other embodiments, a width W1 of the optical device 10 along the Z-direction is between about 5 mm to about 6 mm, with a diameter d1 of the fiber 124 being about 0.08 mm, a pitch P1 of the fibers 124 on the same row being about 0.085 mm, and a diameter d1 of the pin 182/184 being about 0.6 mm. In some embodiments, the location of the pin 182/184 may vary as long as at least two pins 182/184 are presented on the plug housing 160. Referring back to FIG. 2, the dimensions of the plug housing 160 set forth may provide a compact arrangement of a plurality of PICs co-packaged with the EIC so as to obtain a CPO platform capable of sustaining rapid data growth and supporting high-bandwidth applications

In some embodiments, the groove 126 or the groove 128 has a V-shaped profile from the perspective along the X-direction. The profiles of strip protrusions 162 and 164 are matched with the profiles of the grooves 126 and 128. When the plug housing 160 is engaged with the collimator array 100, the relative position of plug housing 160 and the collimator array 100 is fixed on the Z-direction.

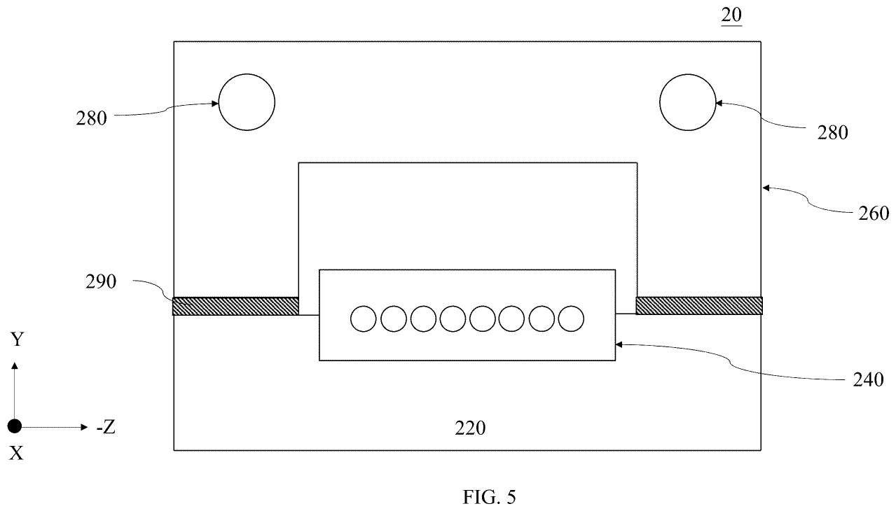

FIG. 5 is a schematic diagram of the optical component 20 viewing from a Y-Z plane according to some embodiments of the present disclosure. Corresponding to the pin 182 and/or the pin 184 of the optical device 10 shown in FIG. 4, the receiving portion 280 of the optical component 20 includes one or more pin holes 280 which is machined to accommodate the pin 182/184. Also different from that the plug housing 160 being fixated to the plate holder 122 through strip protrusions and grooves, the receptacle housing 260 is fixated to the PIC 220 through an adhesive 290 after an alignment operation described in FIG. 13A and FIG. 13B of the present disclosure.

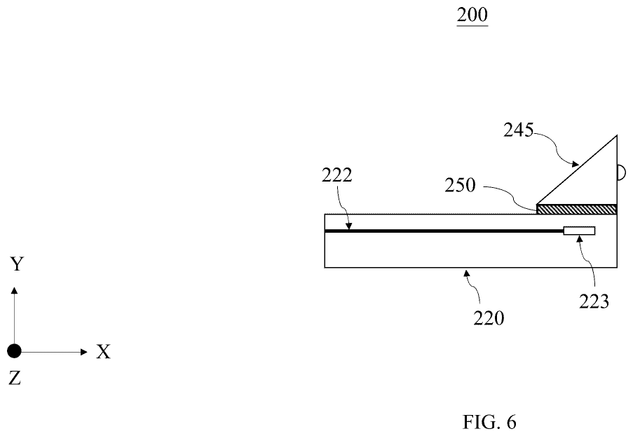

As shown in FIG. 3, the PIC lens array 240 is edge coupled to the PIC 220 to form the PIC array 200, where the PIC lens array 240 is at least partially overlapped, in a lateral direction, with the PIC 220 for optical coupling. It could be noted that for edge coupling, a plate-type lens array can be adopted as the PIC lens array 240, and the adhesive 270 is applied to a lateral surface of the plate-type lens array in conjunction to the lateral surface of the PIC 220. However, the present disclosure is not limited thereto. In various embodiments, other way of coupling between the PIC lens array 240 and the PIC 220 may be applied. For example, FIG. 6 is a schematic diagram of a PIC array 200 with the PIC lens array 245 surface coupled to the PIC 220, where the PIC lens array 245 is at least partially overlapped, in a vertical direction, with the PIC 220 for optical coupling. It could be noted that for surface coupling, a prism-type lens array can be adopted as the PIC lens array 245, and the adhesive 250 is applied to a bottom face of the prism-type lens array in conjunction to the top surface of the PIC 220. In some embodiments, when the prism-type lens is adopted, the PIC 220 further includes a grating coupler 223 coupled to an end of respective waveguides 222. The grating coupler 223 is configured to optically align the waveguides to the PIC lens array 245. More specifically, the grating coupler 223 is configured to couple the light transmitted through the waveguide 222 upwardly (i.e., along the Y-direction) to the PIC lens array 245, and vice versa. Either way, the receptacle housing 260 can be correspondingly machined to accommodate the prism-type lens array for surface coupling or the plate-type lens array for edge coupling.

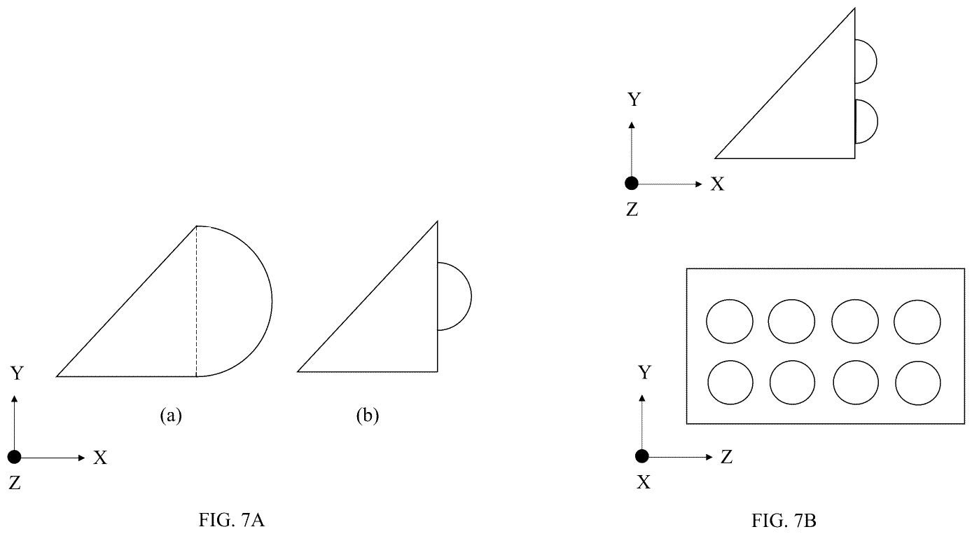

In connection to the prism-type lens array depicted in FIG. 6, the PIC lens array 245 may have different alternatives in terms of lens arrangement and dimension. The PIC lens array 245 may include a single row lens array illustrated in FIG. 7A or multi-row lens array illustrated in FIG. 7B. In the single row option as in FIG. 7A, the prism-type lens array (a) can be a one-part design, and the prism-type lens array (b) can be an assembly having one or more plano-convex lens integrated with a prism. In the multi-row option as in FIG. 7B viewing from the X-Y plane or the Y-Z plane, two or more rows of the plano-convex lens can be arranged in an evenly separated manner.

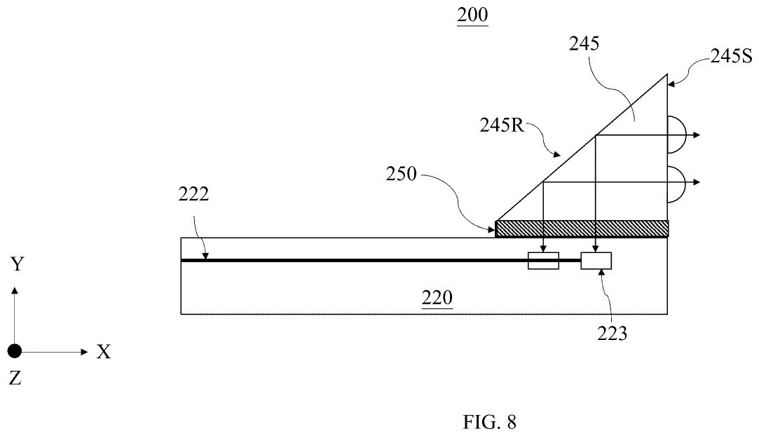

FIG. 8 is a schematic diagram of the PIC array 200 having multi-row lens array according to some embodiments of the present disclosure. The reflected surface 245R allows the PIC lens array 245 to reflect light at different height levels along Y-direction, and enter different rows of the lens array at different height levels along Y-direction. Based on the multi-row configuration, the number of optical channels can be increased for greater data transmission per unit area.

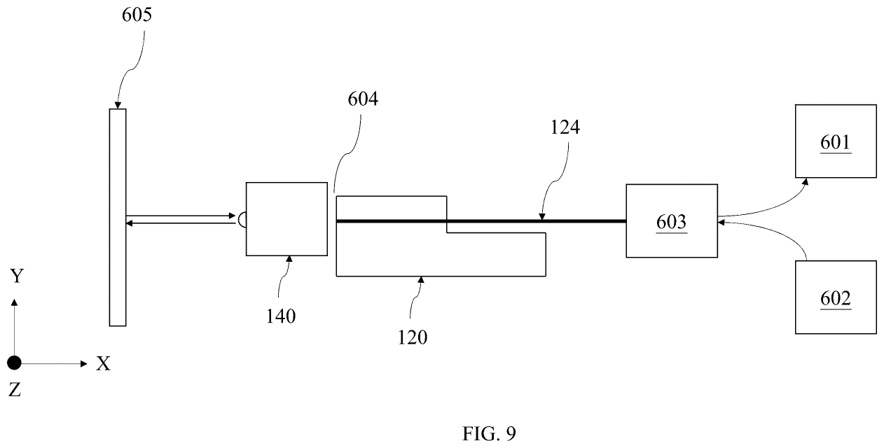

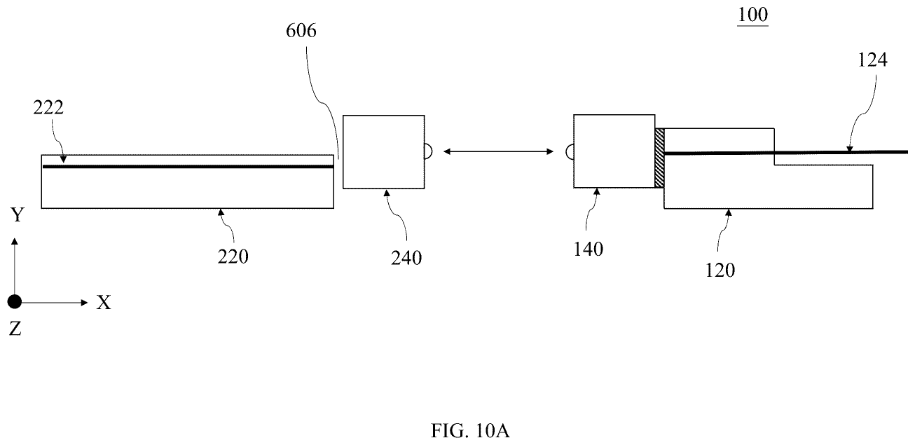

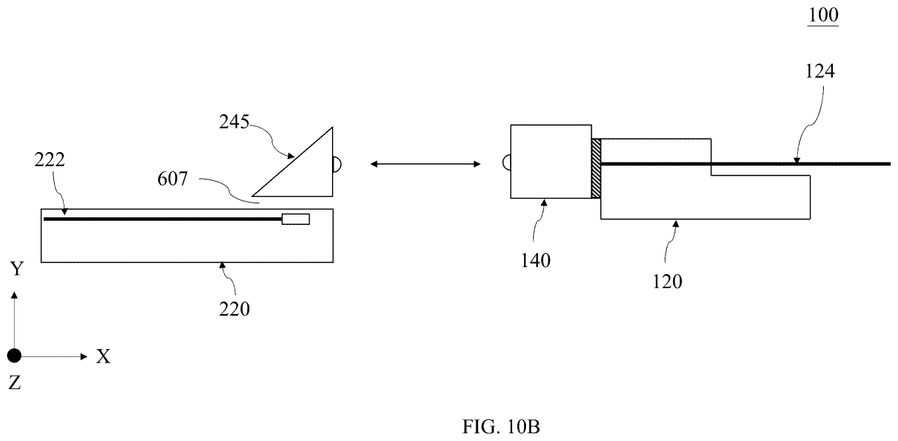

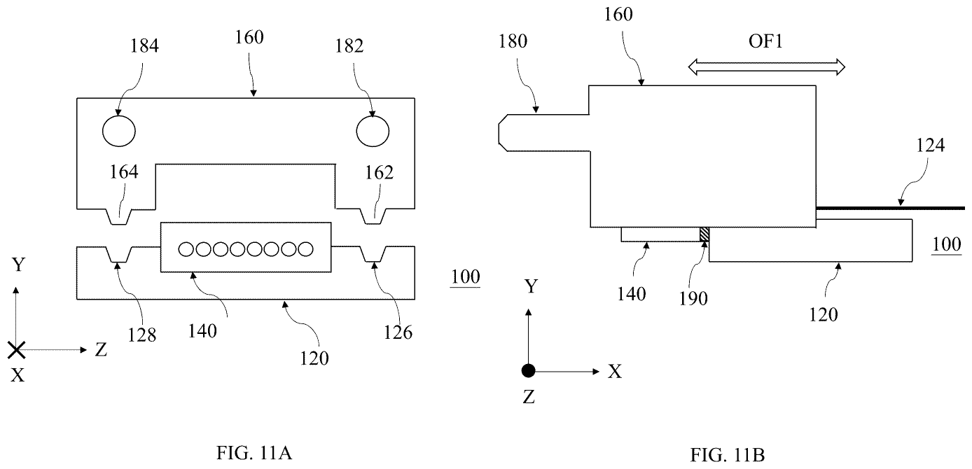

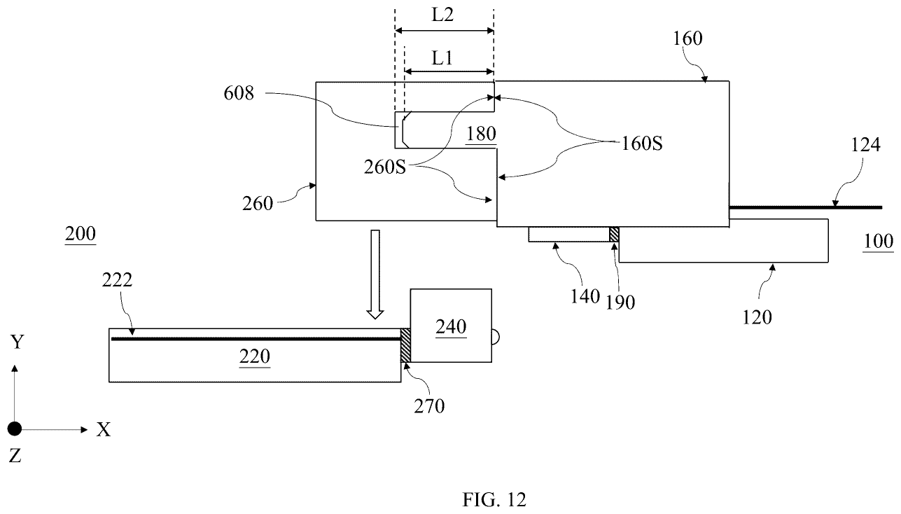

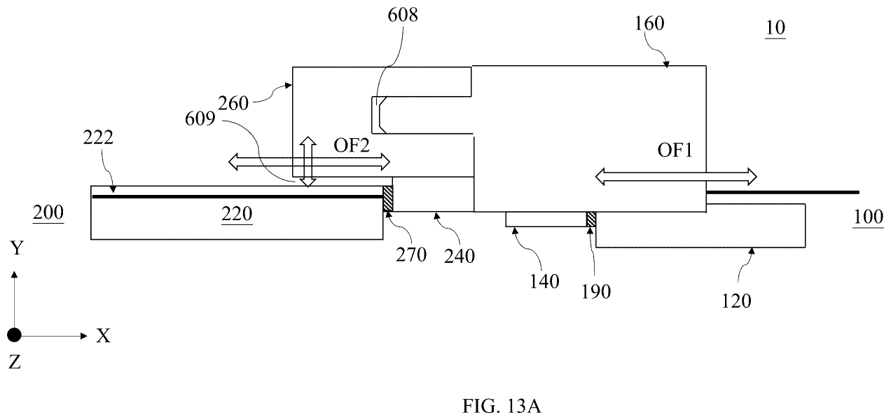

FIGS. 9, 10A, 10B, 11A, 11B, 12, 13A, 13B, and 13C are schematic diagrams of intermediate stages of a method of forming the optical assembly 1 according to some embodiments of the present disclosure.

In FIG. 9, the fiber array 120 is aligned with the collimator lens array 140 through an active alignment operation. For example, the fibers 124 on the fiber array 120 are connected to an external power meter 601 and an external light source 602 through an external coupler 603. The external light source 602 is configured to generate a test laser beam inputting to the fiber array 120. At the onset of the alignment, the collimator lens array 140 is disposed adjacent to the fiber array 120 along the optical path with a gap 604 therebetween. The collimator lens array 140 couples the test laser beam from the fibers 124 and transmits the same to a reflector 605, such as a mirror, at a lower stream of the optical path. The reflector 605 reflects the test laser beam back to the collimator lens array 140, the fibers 124 of the fiber array 120, the external coupler 603, and then enter into the external power meter 601. The power of the reflected test laser beam measured by the external power meter 601 varies during the active alignment operation until an optimal value of the power is reached, and the active alignment between the collimator lens array 140 and the fiber array 120 can be concluded and followed by a fixation operation. The fixation operation includes, but not limited to, solidifying an adhesive material filling the gap 604 between a sidewall of the collimator lens array 140 and a sidewall of the fiber array 120 by performing a curing operation to the adhesive material (e.g., epoxy-based material). It is understandable that prior to solidifying the adhesive material, relative positions of the collimator lens array 140 and the fiber array 120 can be adjusted as needed to obtain the optimal power during active alignment. After solidifying the adhesive material, the collimator array 100 is obtained, as illustrated in FIG. 10A.

Referring to FIG. 10A, the PIC 220 is aligned with an edge coupled PIC lens array 240 through an active alignment operation. At the onset of the alignment, the PIC lens array 240 is disposed adjacent to the PIC 220 along the optical path with a gap 606 therebetween. An external test laser beam propagates through the waveguides 222 and enter the PIC lens array 240, the collimator lens array 140, the fiber array 120, and coupled to the external power meter (omitted here). The power of the test laser beam measured by the external power meter varies during the active alignment operation until an optimal value of the power is reached, which may occur when a minimal insertion loss (IL) is found, alignment between the PIC lens array 240 and the PIC 220 can be concluded and followed by a fixation operation. The active alignment set forth can be performed several times for multiple channel pairs between the PIC 220 and the fiber array 120. The fixation operation includes, but not limited to, solidifying an adhesive material filling the gap 606 between a sidewall of the PIC lens array 240 and a sidewall of the PIC 220 by performing a curing operation to the adhesive material (e.g., epoxy-based material). It is understandable that prior to solidifying the adhesive material, relative positions of the PIC lens array 240 and the PIC 220 can be adjusted as needed to obtain the optimal power during active alignment. After solidifying the adhesive material, the PIC array 200 is obtained, as illustrated in FIG. 12.

Referring to FIG. 10B, the PIC 220 is aligned with a surface coupled PIC lens array 245 through an active alignment operation. At the onset of the alignment, the PIC lens array 245 is disposed above the PIC 220 with a gap 607 therebetween. The procedure of active alignment between PIC 220 and the surface coupled PIC lens array 245 is similar to those described in FIG. 10A and is omitted here for brevity.

In FIG. 11A, the plug housing 160 is in a process of engaging to the collimator array 100. For example, the plug housing 160 has at least one or more than one of strip protrusions 162/164 at a bottom face of the plug housing 160 which is configured to engage with the corresponding grooves 126/128 on a top face of the collimator array 100 through a sliding operation. Because the profiles of the strip protrusions 162 and 164 are matched with the profiles of the grooves 126 and 128 when viewing from the Y-Z plane, the offset between the plug housing 160 and the collimator array 100 along the Z-direction is limited. However, after the plug housing 160 is engaged to the collimator array 100, an offset OF1 between the plug housing 160 and the collimator array 100 along the X-direction can still be created as illustrated in FIG. 11B because the strip protrusion may be movable in the corresponding groove along the X-direction. It should be noted that although the plug housing 160 is engaged to the collimator array 100, the plug housing 160 is not fixated on the collimator array 100 with any adhesive as shown in FIG. 11B. Since the engagement between the plug housing 160 and the collimator array 100 is performed without using any test laser beam or power meter, such engagement is referred as a passive alignment operation herein. Advantage of a passive alignment operation includes simplifying the assembling procedures of the optical assembly 10/30 and 20/40 with sufficient precision.

In FIG. 12, the receptacle housing 260 is detachably coupled to the plug housing 160 when the plug hosing 160 is engaged with the collimator array 100. In some embodiments, when engaging the receptacle housing 260 to the plug housing 160, the detachable coupling means 180/380 (e.g., the pin 182 in FIG. 3, the pin 382 in FIG. 14, and/or the arc piece structure 132 in FIG. 14) is inserted into the receiving portion 280/480 (e.g., the recess structure in FIG. 3, the recess portion 482 in FIG. 14, and/or the pin hole 484 in FIG. 14), and the side surface 160S of the plug housing 160 is in contact with the side surface 260S of the receptacle housing 260. As shown in FIG. 12, the length L1 of the detachable coupling means 180 is less than the length L2 of the receiving portion 280. Thus, a gap 608 exists between a tip of the detachable coupling means 180 and an inner sidewall of the receiving portion 280.

In FIG. 13A and FIG. 13B, the receptacle housing 260 engaged with the plug housing 160 is brought into close proximity of the PIC array 200 for an active alignment operation between the collimator array 100 and the PIC array 200, or essentially between the PIC lens array 240 and the collimator lens array 120. At the onset of the alignment, the receptacle housing 260 is disposed above the PIC 220 with a gap 609 therebetween. An external test laser beam propagates through the waveguides 222 and enter the PIC lens array 240, the collimator lens array 140, the fiber array 120, and coupled to the external power meter (omitted here). The power of the test laser beam measured by the external power meter varies during the active alignment operation until an optimal value of the power is reached, which may occur when a minimal insertion loss (IL) is found, alignment between the PIC lens array 240 and the collimator lens array 140 can be concluded and followed by a fixation operation. During the aforesaid active alignment operation, an offset OF2 between the receptacle housing 260 and the PIC array 200 in any angle or distance becomes a movable degree of freedom to optimize the alignment result. It should be noted that the offset OF1 still exists in this stage as another movable degree of freedom. That is, this active alignment is performed to determine the desired relative position between the receptacle housing 260 and the PIC array 200 and the desired relative position between the plug housing 160 and the collimator array 100.

After the alignment between the PIC lens array 240 and the collimator lens array 140, the fixation operation fixating the receptacle housing 260 and the PIC array 200 is performed. The fixation operation includes, but not limited to, solidifying an adhesive material filling the gap 609 between the bottom face of the receptacle housing 260 and the top face of the PIC array 200 by performing a curing operation to the adhesive material (e.g., epoxy-based material). It is understandable that prior to solidifying the adhesive material, relative positions of the receptacle housing 260 and the PIC array 200 can be adjusted as needed to obtain the optimal power during active alignment. After solidifying the adhesive material, the movable degree of freedom of the optical assembly 10/30 and 20/40 is reduced under optimal insertion loss, as illustrated in FIG. 13B.

After solidifying the adhesive material, the movable degree of freedom of the optical assembly 10/30 and 20/40 is reduced under optimal insertion loss, as illustrated in FIG. 13B. In FIG. 13C, the optical device 10 is disengaged from the optical component 20 by separating the fixated PIC array 200 and the receptacle housing 260 from the plug housing 160 engaged to the collimator array 100. After all the alignment operations set forth, the optical device 10 can later plug in and out from the optical components 20 with desirable insertion loss without repeating alignments.

FIG. 14 is a schematic diagram of an optical assembly 5 according to some embodiments of the present disclosure. The optical assembly 5 includes the optical device 30 and the optical component 40. The optical device 30 can be a collimator array with a plug mechanism, as opposed to the optical component 40 which can be a PIC with a receptacle mechanism, where the plug mechanism can detachably couple to the receptacle mechanism and provide a reliable light coupling effect. The collimator array 100 in FIG. 14 and FIG. 3 can be substantially identical and can be referred thereto for brevity. Compared to the optical device 10 of FIG. 3, the optical device 30 of FIG. 14 includes a plug housing 360 and a detachable coupling means 380 different from those of the optical device 10.

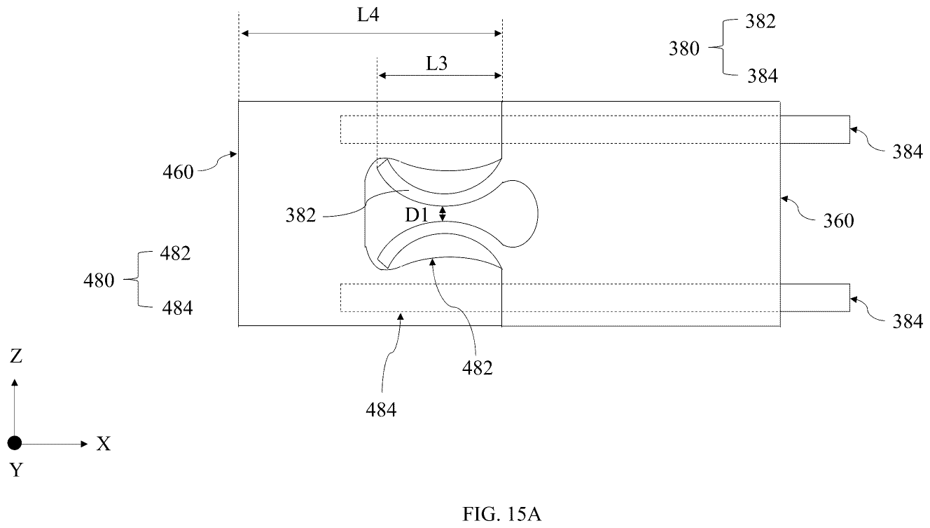

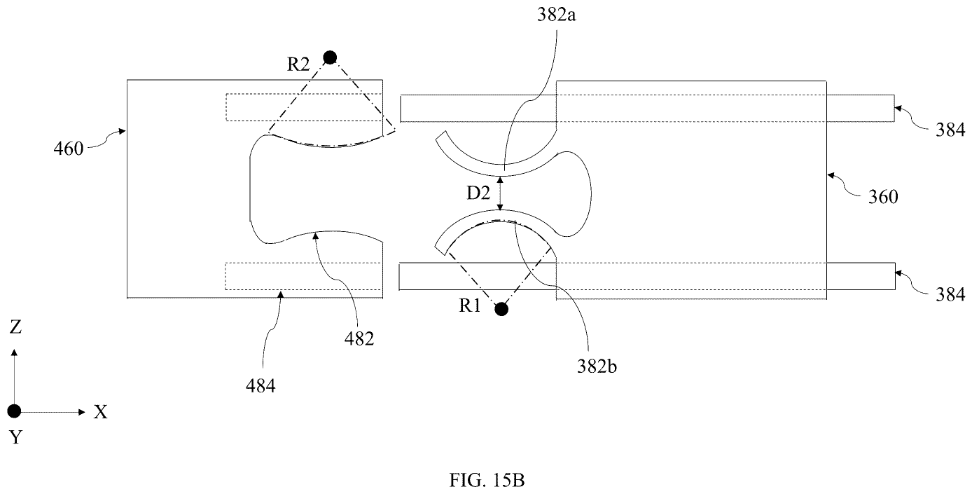

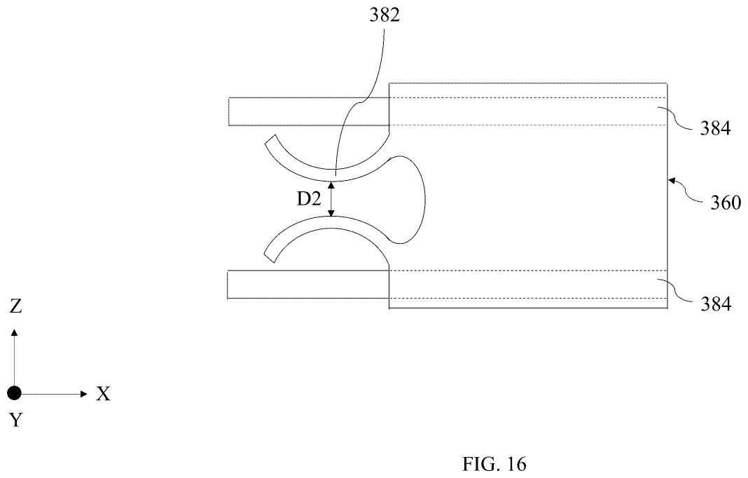

Similar to the plug housing 160, the plug housing 360 is fixated to the collimator array 100. For the optical device 30, the detachable coupling means 380 includes at least an arc piece structure 382 protruding from a side surface of the plug housing 380 and being parallel along the longitudinal direction (i.e., the X-direction) of the fibers 124. Different from the detachable coupling means 180 previously described in FIG. 3, the arc piece structure 382 provides an additional gripping mechanism to detachably couple the plug housing 360 and the receptacle housing 460. More details of the arc piece structure 382 can be found in FIG. 15A, FIG. 15B, and FIG. 16 of the present disclosure. Optionally, the detachable coupling means 380 further includes at least a pin 384 protruding from the side surface of the plug housing 380 and being parallel along the longitudinal direction (i.e., the X-direction) of the fibers 124. As illustrated in FIG. 14, the arc piece structure 382 and the pin 384 are located at different height levels along the Y-direction. With the application of both the pin 384 and the arc piece structure 382, the engagement position, or plug-in position referred herein, can maintain highly consistent without offset after multiple plug-in operations, and provide better stability of optical coupling figure of merit (e.g., insertion less, etc.).

In some embodiments, the pin 384 traverses the plug housing 360 through a through hole of the plug housing 360. In other embodiments, the pin 384 and the plug housing 360 are a monolithic structure (not shown) made of the same material. In various embodiments, the arc piece structure 382 and the plug housing 360 are a monolithic structure made of the same material. In alternative embodiments, the detachable coupling means 380 and the plug housing 360 are a monolithic structure made of the same material.

The PIC array 200 in FIG. 14 and FIG. 3 can be substantially identical and can be referred thereto for brevity. Compared to the optical component 20 of FIG. 3, the optical component 40 of FIG. 14 includes a receptacle housing 460 and a receiving portion 480 different from those of the optical component 20. Similar to the receptacle housing 260, the receptacle housing 460 is fixated to the PIC array 200. The receiving portion 480 of the optical component 40 is at a side surface of the receptacle housing 460 and configured to detachably couple to the plug housing 360 through the detachable coupling means 380. The receiving portion 480 at least includes a recess structure 482 configured to receive the arc piece structure 382 of the plug housing 360. The recess structure 482 provides an additional gripping mechanism to detachably couple the plug housing 360 and the receptacle housing 460. More details of the recess structure 482 can be found in FIG. 15A and FIG. 15B of the present disclosure. Optionally, the receiving portion 480 further includes at least a pin hole 484 recessed from the side surface of the receptacle housing 460 and being parallel along the X-direction. The pin hole 484 is designed to accommodate the pin 384 as previously described with the optical device 30. In correspondence to the arc piece structure 382 and the pin 384 of the optical device 30 and as shown in FIG. 14, the recess structure 482 and the pin hole 484 are located at different height levels along the Y-direction.

FIG. 15A and FIG. 15B are schematic diagrams of the plug housing 360, the detachable coupling means 380, the receptacle housing 460, and the receiving portion 480 viewing from an X-Z plane according to some embodiments. FIG. 15A shows that the plug housing 360 and the receptacle housing 460 are detachably coupled, and FIG. 15B shows that the plug housing 360 is disengaged from the receptacle housing 460.

In FIG. 15A, when the plug housing 360 is detachably coupled to the receptacle housing 460, the arc piece structure 382 is engaged with the recess structure 482. For example, the arc piece structure 382 can be two separate pieces of arc-shaped articles made of deformable material (e.g., plastic) arranged back-to-back. The arc-shaped articles each appears as a reverse hook clasp. The deformable material demonstrates sufficient resilient property so that the arc piece structure 382 is slightly deformed when fitted into the recess structure 482. A measure for the aforesaid deformation can be a minimal distance D1 between the pair of arc-shaped articles. In FIG. 15B, when the plug housing 360 is disengaged with the receptacle housing 460, the arc-shaped articles are back to their original position free of deformation and can be measured with a minimal distance D2 between the pair of arc-shaped articles. As a result, the distance D1 is less than the distance D2. In some embodiments, a difference between the distance D1 and the distance D2 is about 0.05 mm to about 0.2 mm.

When the optical device 30 is coupled with the optical component 40, the arc piece structure 382 is in contact with a sidewall of the recess structure 482 and provides a gripping or pulling force, or so-called static friction force, between the arc piece structure 382 and the recess structure 482. Such gripping or pulling force prevents the plug housing 360 from disengaging the receptacle housing 460 when external vibration is exerted to the optical assembly 5 during device operation on a system level. In some embodiments, the gripping or pulling force is about 150 gf to about 500 gf along the X direction. Referring to FIG. 2 and FIG. 15A, taking A side array for example, the engagement direction of the arc piece structure 382 is in the X direction in order to allow compact arrangement of the optical components 20/40 and optical device 10/30 combo positioned along the Z direction and thereby increase the density of the combo surrounding the EIC 3.

Referring to FIG. 15A, the arc piece structure 382 has a length L3 measured from a sidewall of the plug housing 360 to a tip of the arc-shaped article along the X-direction, and the receptacle housing 460 has a length L4 measured from a sidewall to an opposite sidewall of receptacle housing 460 the along the X-direction. In some embodiments, the length L4 is less than two times of the length L3, that is, the length L3 is greater than half of the length L4, in order to achieve optimum gripping or pulling effect.

As shown in FIG. 15B, another measure is provided to characterize the deformable and resilient property of the arc piece structure 382. When the plug housing 360 is disengaged from the receptacle housing 460, one of the arc-shaped article, i.e., 382a or 382b possesses a radius of curvature R1. A sidewall surface of the recess structure 482 may also has a measurable curve and possessing a radius of curvature R2. The radius of curvature R1 associated with the arc piece structure is smaller than the radius of curvature R2 associated with the recess structure 482 so as to generate the aforementioned gripping or pulling force after engagement. It is understandable that a certain level of force shall be exerted to the plug housing 360 and the receptacle housing when engaging the two. In some embodiments, the radius of curvature R1 associated with the arc piece structure 382 is about 40% to about 60% of the radius curvature R2 associated with the recess structure 482.

Referring to FIG. 15B, in some embodiments, a length of the pin 384 is greater than an entire length of the plug housing 360 such that the pin 384 protrudes from opposite sidewalls of the plug housing 360 facing a direction away from or toward the receptacle housing 460. In this connection, the pin 384 can be a component separable from the plug housing 360. In some embodiments, the pin 384 in FIG. 15 provides an engagement guiding purpose and has a length from about 0.5 mm to about 0.7 mm.

FIG. 16 is a schematic diagram of a plug housing 360 according to some embodiments of the present disclosure. Different from the plug housing 360 illustrated in FIG. 15B, the pin 384 shown in FIG. 16 only protrudes from the sidewall fan-out the plug housing 360 facing a direction toward the receptacle housing 460. In this connection, the pin 384 in FIG. 16 can be a monolithic piece together with the plug housing 360 and the arc piece structure 382. Alternatively stated, the pin 384, the plug housing 360, and the arc piece structure 382 can be made of same suitable material. In some embodiments, the pin 384 in FIG. 16 provides an engagement guiding purpose and has a length from about 0.5 mm to about 0.7 mm. The pin configuration in FIG. 16 can reduce possible operational interference to the fibers 124 on the collimator array 100 especially when a multi-row fiber array is implemented.

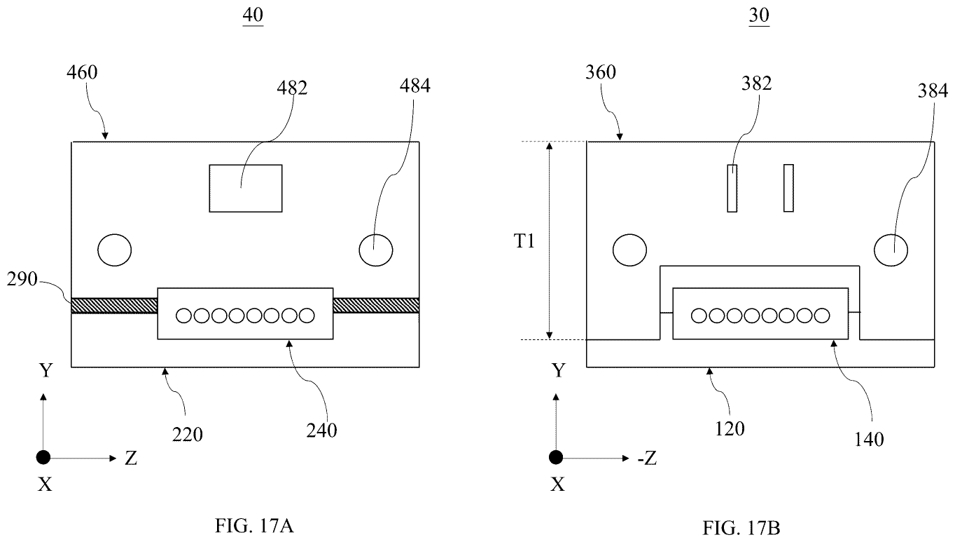

FIG. 17A and FIG. 17B are schematic diagrams of the optical component 40 and the optical device 30 viewing from a Y-Z plane according to some embodiments of the present disclosure. An X-Y plane perspective of FIG. 17A and FIG. 17B can be referred to the optical assembly 5 of FIG. 14. In FIG. 17B, the plug housing 360 has a thickness T1 along the Y-direction. When the design of the plug housing 360 has a sufficient thickness T1, for example, greater than a combined vertical dimension of the arc piece structure 382 and the pin 384, the arc piece structure 380 and the pin 384 can be arranged at different levels along the Y-direction. Similarly, in FIG. 17A, the pin hole 484 and the recess structure 482 of the receptacle housing 460 are designed in correspondence to their respective counterparts and located at different levels along the Y-direction.

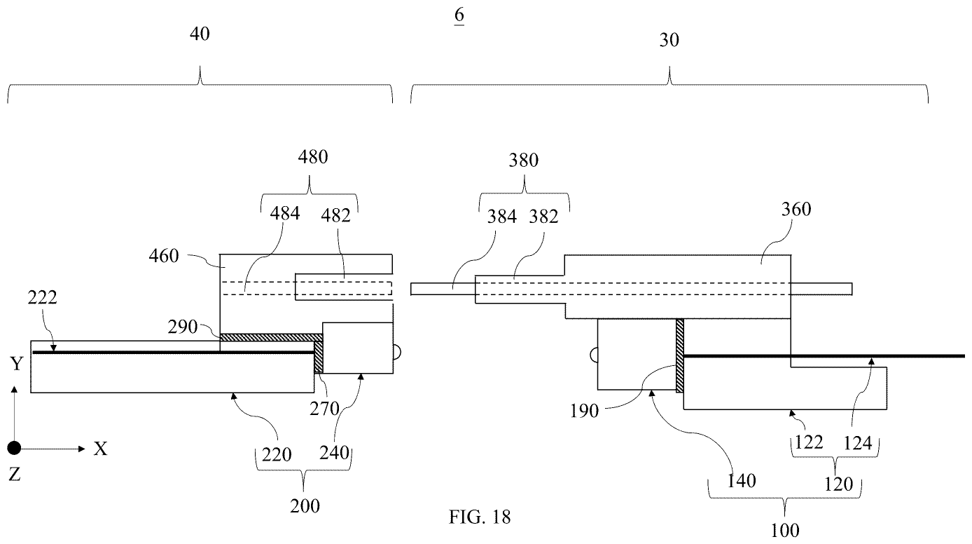

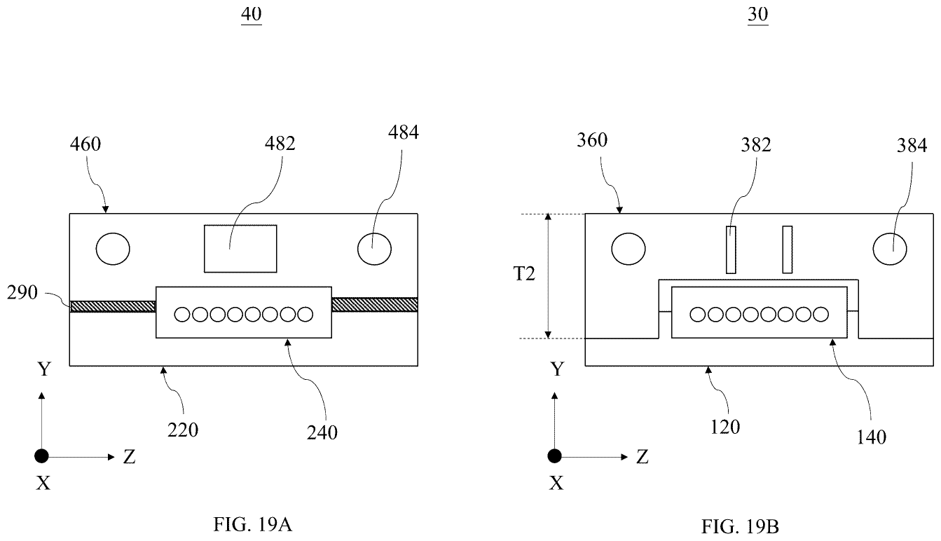

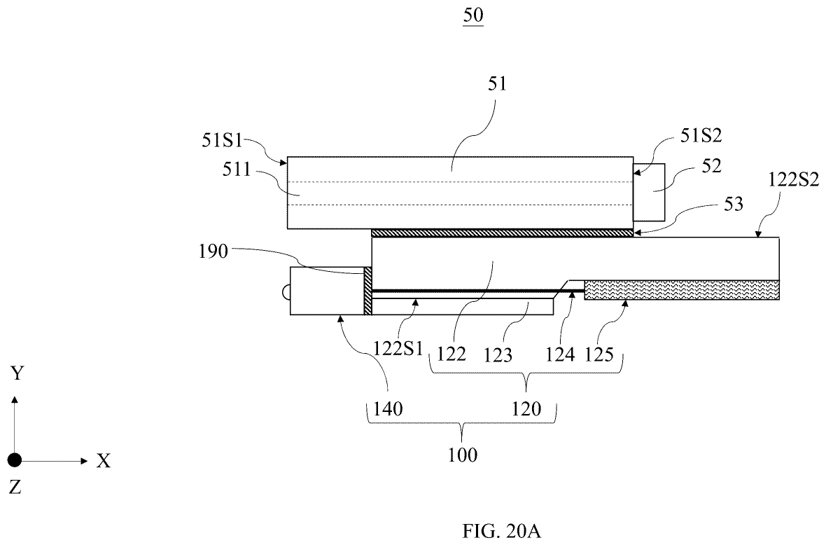

FIG. 19A, and FIG. 19B, are schematic diagrams of the optical component 40 and the optical device 30 viewing from a Y-Z plane according to some embodiments of the present disclosure. An X-Y plane perspective of FIG. 19A and FIG. 19B can be referred to the optical assembly 6 of FIG. 18. In FIG. 19B, the plug housing 360 has a thickness T2 along the Y-direction. When the design of the plug housing 360 has a limited thickness T2, for example, smaller than a combined vertical dimension of the arc piece structure 382 and the pin 384, the arc piece structure 380 and the pin 384 can be arranged substantially laterally leveled, for example, along the Z direction. Similarly, in FIG. 19A, the pin hole 484 and the recess structure 482 of the receptacle housing 460 are designed in correspondence to their respective counterparts and located substantially laterally leveled along the Z direction.

In respect to methods of forming the optical assembly 5 of FIG. 14 and the optical assembly 5 of FIG. 18 can be referred to the description associated with FIGS. 9, 10A, 10B, 11A, 11B, 12, 13A, 13B, 13C, and are not repeated here for brevity.

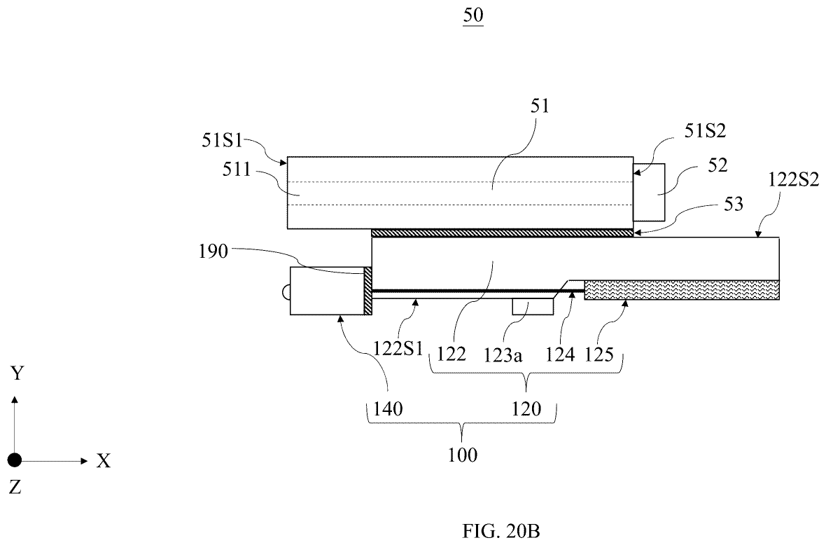

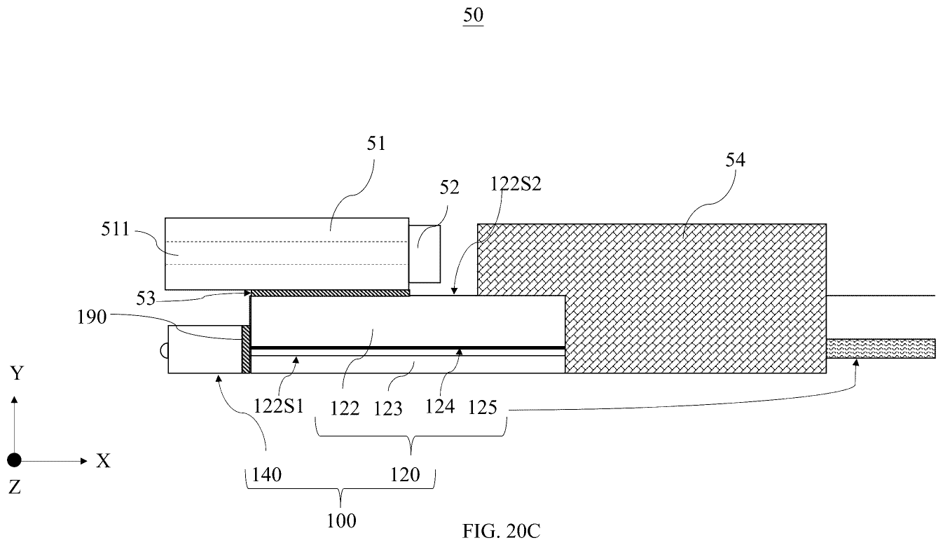

FIG. 20A, FIG. 20B, FIG. 20C are schematic diagrams an optical device 50 according to some embodiments of the present disclosure. In some embodiments, the optical device 50 has similar components to the optical device 10, such as the fiber array 120, the collimator lens array 140, and the adhesive 190.

The optical device 50 includes the collimator array 100, a receptacle housing 51, and an anti-slip collar 52. The collimator array 100 includes the fiber array 120 and the collimator lens array 140. The fiber array includes the plate holder 122, the fibers 124, and a lid 123. The fibers 124 are disposed on a first surface 122S1 of the plate holder 122 and carried by the plate holder 122. The lid 123 is configured to cover the plate holder 122 from the first surface 122S1. As shown in FIG. 20A, the first surface 122S1 faces downward (negative Y direction), and the lid 123 is used to prevent the fibers 124 from falling. In some embodiments, the lid 123 can be omitted.

The fibers 124 extend along the X direction. The lid 123 covers the fibers 124 on a protruding part of the first surface 122S1, and at a recessed area on the first surface 122S1, the fibers 124 are wrapped by claddings 125. It should be noted that the fibers 124 indicate the fiber core for transmitting optical signal in the fiber structure, and the claddings 125 indicate the outer shell of the fiber structure for protecting the core and preventing the optical signal from leaking.

The collimator lens array 140 is fixated to the fiber array 120 by the adhesive 190 and optically coupled to the fibers 124.

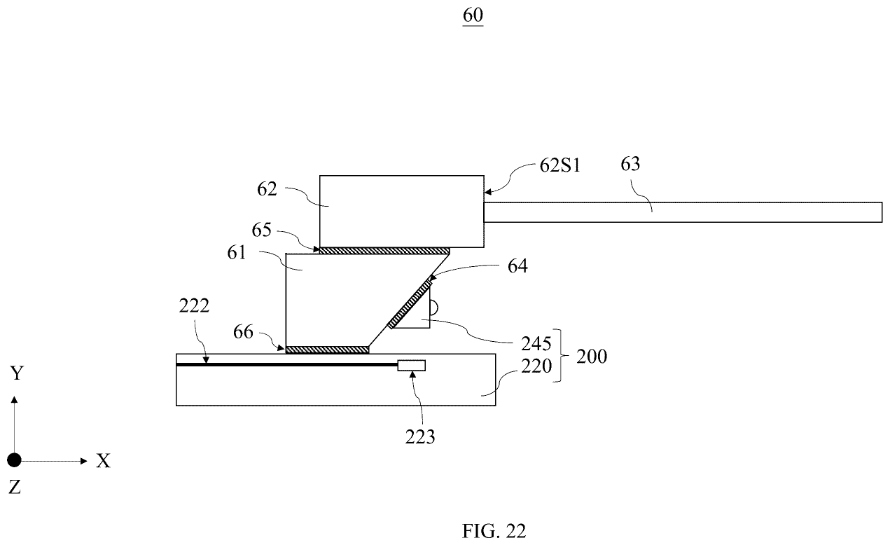

The receptacle housing 51 is fixated to the collimator array 100 in part by an adhesive 53. Specifically, the receptacle housing 51 is fixated to a second surface 122S2 of the plate holder 122, where the second surface 122S2 is opposite to the first surface 122S1. The receptacle housing 51 includes a pin hole 511 running through the receptacle housing 51 from a first side surface 51S1 to a second side surface 51S2 opposite to the first side surface 51S1. The pin hole 511 is configured to receive a detachable coupling means (such as a detachable coupling means 63 shown in FIG. 22) of a corresponding plug housing external to the optical device 50, therefore, the receptacle housing 51 can be mechanically coupled to the plug housing.

The anti-slip collar 52 is attached at the second side surface 51S2. In some embodiments, the anti-slip collar 52 is composed of elastomeric material and configured to accommodate the detachable coupling means and provide a friction to the detachable coupling means. In some embodiments, the receptacle housing 51 and the detachable coupling means are made by hard material; when the detachable coupling means is inserted in the pin hole 511, the receptacle housing 51 may be able to restrict the movement of the detachable coupling means in the Y and Z directions, however, the receptacle housing 51 may provide limit restriction to the movement of the detachable coupling means in the X direction. Under this situation, the receptacle housing 51 is designed so that the detachable coupling means can pass through the pin hole 511 and protrude from the second side surface 51S2, allowing the protruding part of the detachable coupling means to be wrapped by and in contact with the anti-slip collar 52. In other words, the detachable coupling means runs through the receptacle housing 51 via the pin hole 511 and is in contact with the anti-slip collar 51 at one end of the detachable coupling means. In this way, the anti-slip collar 52 can provide the friction to the detachable coupling means, restricting the detachable coupling means' movement in the X direction.

As shown in FIG. 20A, a length of the lid 123 along the X direction is substantially equal to a length of the protruding part of the first surface 122S1. In other embodiments, the lid 123 may expose a portion of the protruding part of the first surface 122S1 as shown in FIG. 20B. In FIG. 20B, the lid 123 of the optical device 50 is replaced by a lid 123a, and the lid 123a has a length shorter than the lid 123 along the X direction. The lid 123 a covers a portion of the protruding part of the first surface 122S1 and is away from the collimator lens array 140.

In some embodiments, the optical device 50 further includes a handler 54 fixated to the collimator array 100. The handler 54 has a gripping area configured for a user to hold. The handler 54 is fixated on the second surface 122S2 of the plate holder 122, and is positioned away from the collimator lens array 140 and the receptacle housing 51.

In some embodiments, the usage scenario of the optical device 50 involves multiple engaging and disengaging. When the optical device 50 can be easily engaged and disengaged, the usage efficiency of the optical device 50 can be increased. Additionally, due to the presence of the handler, users can avoid touching the fibers or lens, thereby reducing contamination of the optical components in the optical device 50.

In some embodiments, the handler 54 has a higher tolerance for positioning and does not require accurate alignment (active or passive alignment). Therefore, when the user picks up the optical device 50, it can prevent relative displacement of the components of the optical device 50 that have been aligned, thereby reducing the likelihood of failure of the optical device 50.

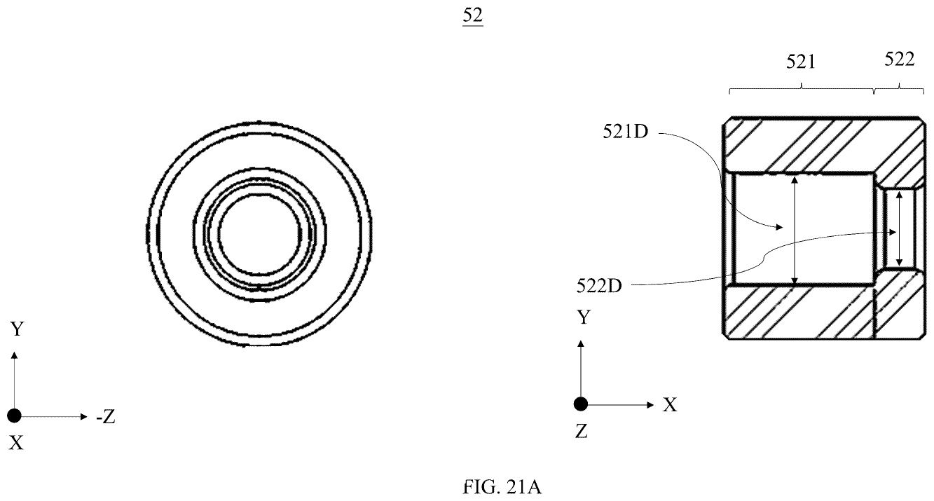

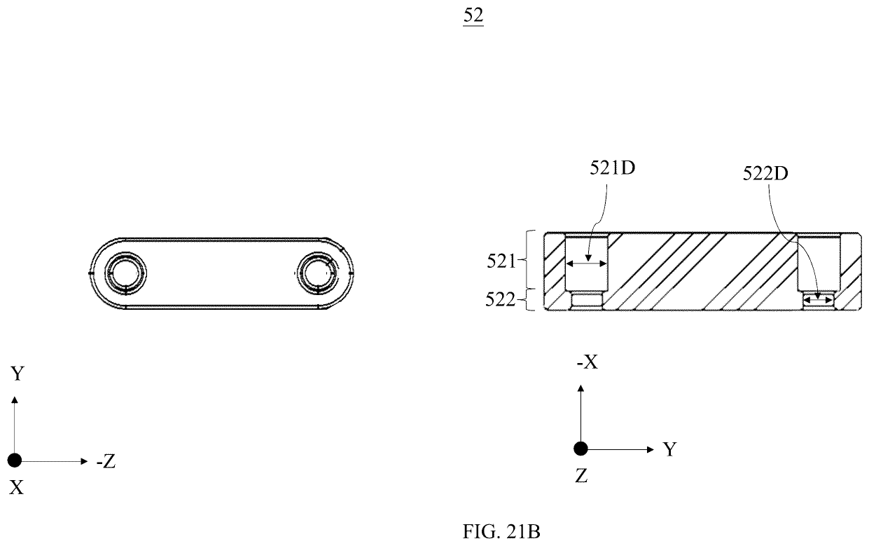

FIG. 21A and FIG. 21B are schematic diagrams of the anti-slip collar 52 according to some embodiments of the present disclosure. The anti-slip collar 52 includes a first portion 521 attached to the second side surface 51S2 and a second portion 522 connected to the first portion 521.

In some embodiments, the first portion 521 and the second portion 522 have the same outer diameter along the Y direction. The first portion 521 has an inner diameter 521D, and the second portion 522 has an inner diameter 522D, wherein the inner diameter 521D is greater than the inner diameter 522D.

In some embodiments, the inner diameter 521D of the first portion 521 is substantially equal to the diameter of the detachable coupling means, while the inner diameter 522D of the second portion 522 is smaller than the diameter of the detachable coupling means. When the detachable coupling means passes through the pin hole 511 and contacts the anti-slip collar 52, it passes through both the first potion 511 and the second portion 512. Because the inner diameter 522D of the second portion 522 is smaller than the diameter of the detachable coupling means, the inner wall of the second portion 522 closely fits against the detachable coupling means, providing frictional force that prevents the detachable coupling means from easily moving in the X direction.

In some embodiments, the receptacle housing 52 includes two pin holes 511 for respectively receiving two detachable coupling means, thereby, the anti-slip collar 52 may have two holes corresponding to the two pin holes 511 as shown in FIG. 21B. In some embodiments, the anti-slip collar 52 is monolithic. In some embodiments, the anti-slip collar 52 includes separated parts corresponding to different pin holes 511.

Reference is made to FIG. 22. FIG. 22 is a schematic diagram of an optical component 60 according to some embodiments of the present disclosure. In some embodiments, the optical component 60 can be a PIC with a plug mechanism, as opposed to the optical device 50 which can be a collimator array with a receptacle mechanism and provide a reliable light coupling effect.

The optical component 60 includes the PIC array 200 which combines the PIC 220 and the PIC lens array 245, a plug housing 62, and a detachable coupling means 63. The PIC 220 includes a plurality of waveguides 222 and the grating coupler 223. The PIC lens array 245 is fixated to the PIC 220 by a support connector 61. Specifically, the PIC lens array 245 is fixated to the support connector 61 by an adhesive 62, and the support connector 61 is fixated to the PIC array 200 by an adhesive 66. The PIC lens array 245 are optically coupled to the waveguides 222 through the grating coupler 223.

The plug housing 62 is fixated to the support connector 61 by an adhesive 65. In some embodiments, the adhesive 64, the adhesive 66, and the adhesive 65 are similar to the adhesive 190 as previously described in optical device 10, and the formations of the adhesive 64, the adhesive 66, and the adhesive 65 are substantially the same as the formation of the adhesive 190.

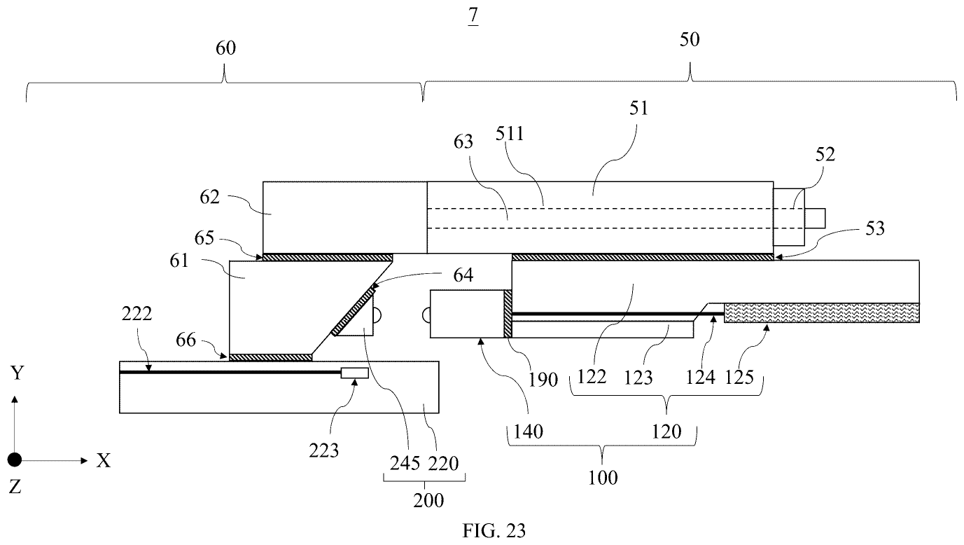

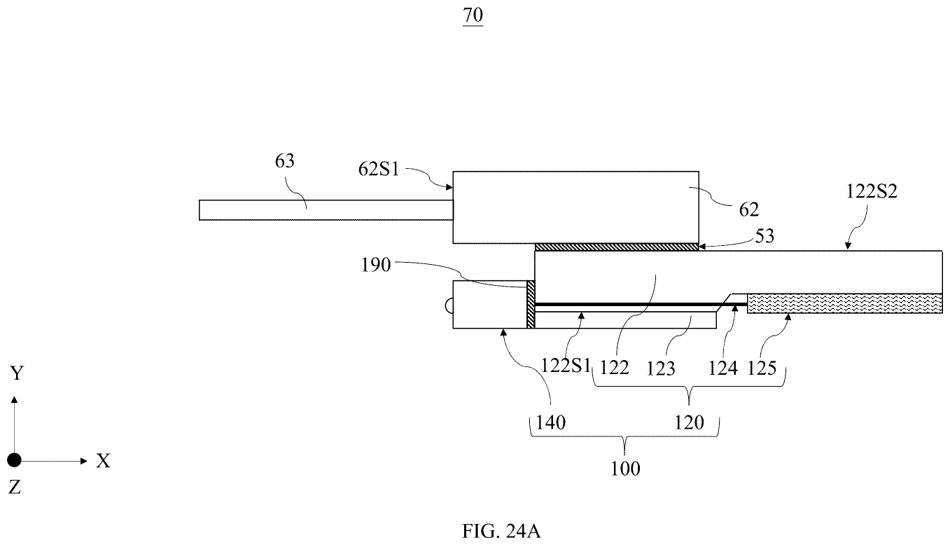

The detachable coupling means 63 protrudes from a side surface 62S1 of the plug housing and running parallel to an axial direction (i.e., the X direction) of the waveguides 222. In some embodiments, the optical device 50 and the optical component 60 are optically coupled through the detachably coupling of the plug mechanism and the receptacle mechanism, for example, through the detachable coupling means 63 and the pin hole 511 of the receptacle housing 51. In some embodiments, the engaged optical device 50 and optical component 60 can be configured as an optical assembly 7 shown in FIG. 23. In the optical assembly 7, the PIC lens array 245 of the optical component 60 is configured to optically align with the collimator lens array 140 of the optical device 50.

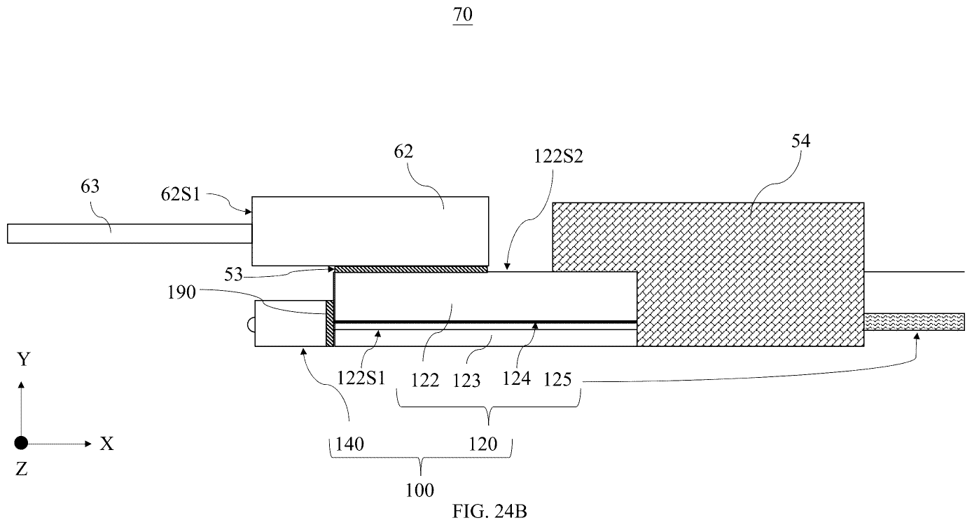

Reference is made to FIG. 24A and FIG. 24B. FIG. 24A and FIG. 24B are schematic diagrams of an optical device 70 according to some embodiments of the present disclosure. The optical device 70 is similar to the optical device 50, except that the plug mechanism of optical device 70 is implemented using the plug housing 62 and the detachable coupling means 63 of the optical component 60. As shown in FIG. 24 A and FIG. 24B, the plug housing 62 is fixated to the collimator array 100 by the adhesive 53. As shown in FIG. 24B, the optical device 70 having the plug housing 62 and the detachable coupling means 63 further includes the handler 54.

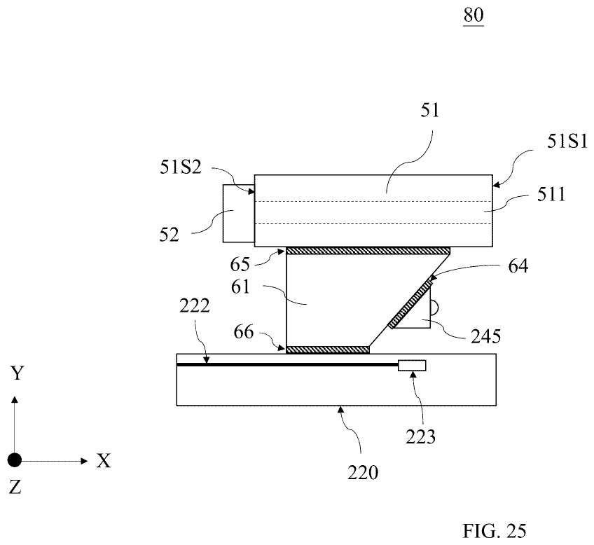

Reference is made to FIG. 25. FIG. 25 is a schematic diagram of an optical component 80 according to some embodiments of the present disclosure. The optical component is similar to the optical component 60, except that the plug mechanism of the optical component 80 is implemented using the receptacle housing 52 and the anti-slip collar 52 of the optical device 50. As shown in FIG. 25, the receptacle housing 51 is fixated to the support connector 62 by the adhesive 65.

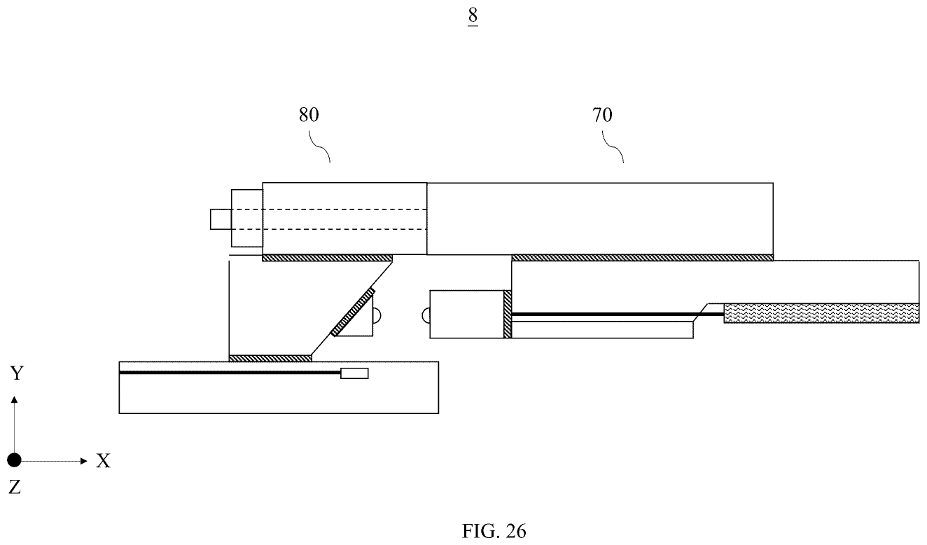

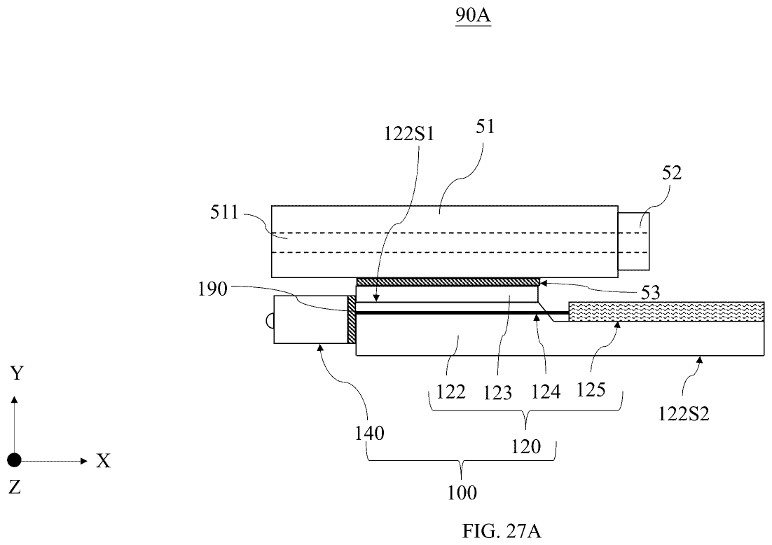

In some embodiments, the optical device 70 and the optical component 80 are optically coupled through the detachably coupling of the plug mechanism and the receptacle mechanism, for example, through the detachable coupling means 63 and the pin hole 511 of the receptacle housing 51. In some embodiments, the engaged optical device 70 and optical component 80 can be configured as an optical assembly 8 shown in FIG. 26.

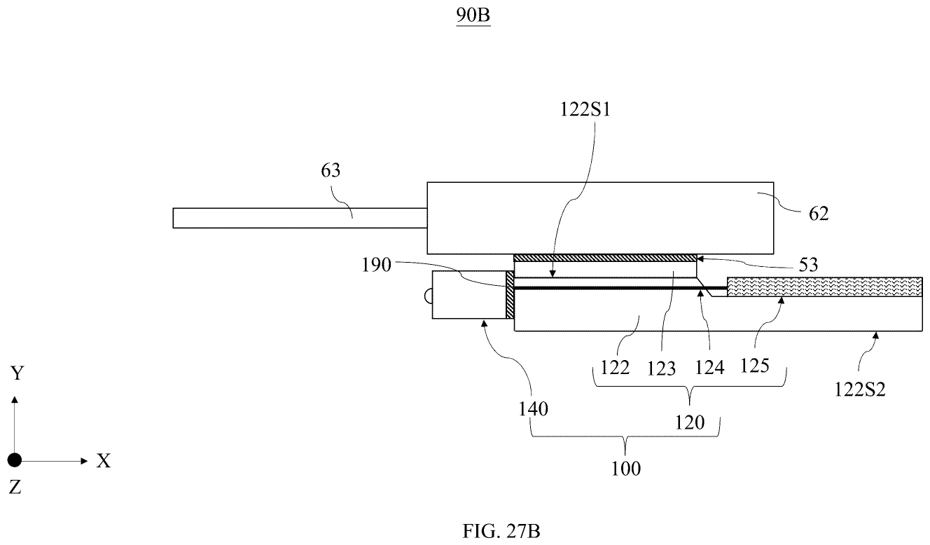

Reference is made to FIG. 27A. FIG. 27A is a schematic diagram of an optical device 90A according to some embodiments of the present disclosure. The optical device 90A is similar to the optical device 50, except that the plate holder 122 of the optical device 90A has its first surface 122S1 facing toward the receptacle housing 51. Specifically, the receptacle housing 51 is fixated to the lid 123 by the adhesive 53.

Reference is made to FIG. 27B. FIG. 27B is a schematic diagram of an optical device 90B according to some embodiments of the present disclosure. The optical device 90B is similar to the optical device 70, except that the plate holder 122 of the optical device 90B has its first surface 122S1 facing toward the plug housing 62. Specifically, the plug housing 62 is fixated to the lid 123 by the adhesive 53.

Because the fibers 124 are positioned on the first surface 122S1, in the optical device 50 (or the optical device 70), the distance between the fiber 124 and the receptacle housing 51 (or the plug housing 62) is relatively large, whereas in the optical device 90A (or the optical device 90B), the distance between the fiber 124 and the receptacle housing 51 (or the plug housing 62) is relatively small. Based on this design flexibility, users can choose to connect using either implementation of the optical device 50/70 or optical device 90A/90B according to the distance between the PIC lens array and the plug housing (or the receptacle housing) of the corresponding optical component.

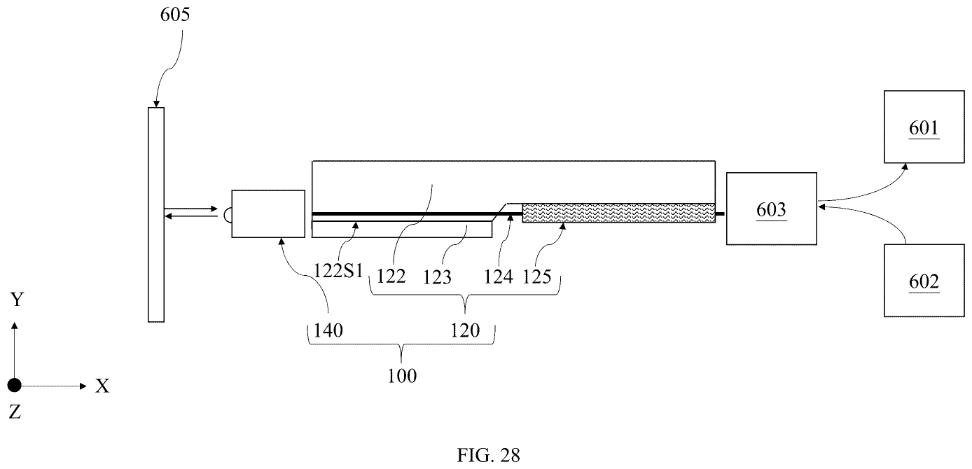

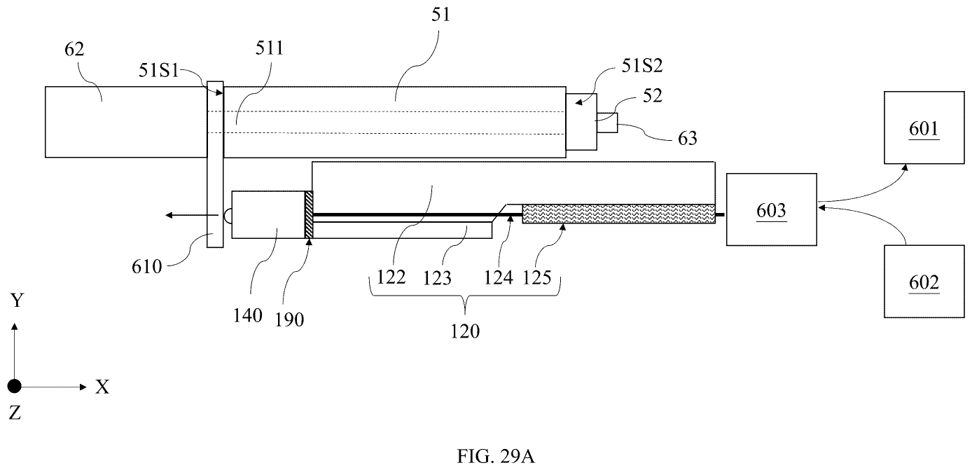

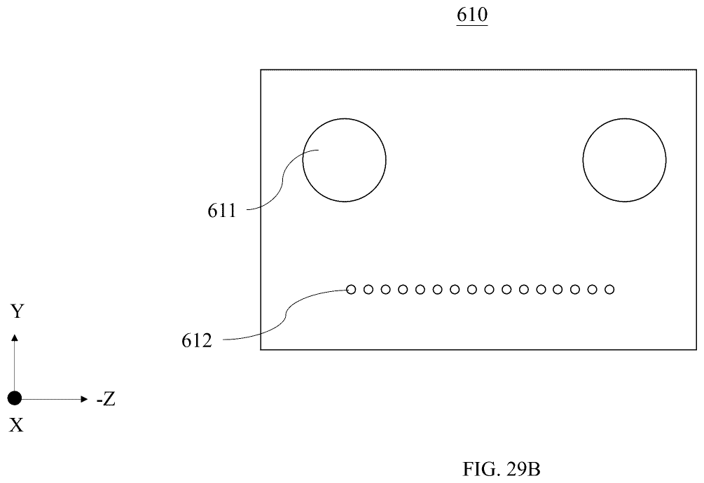

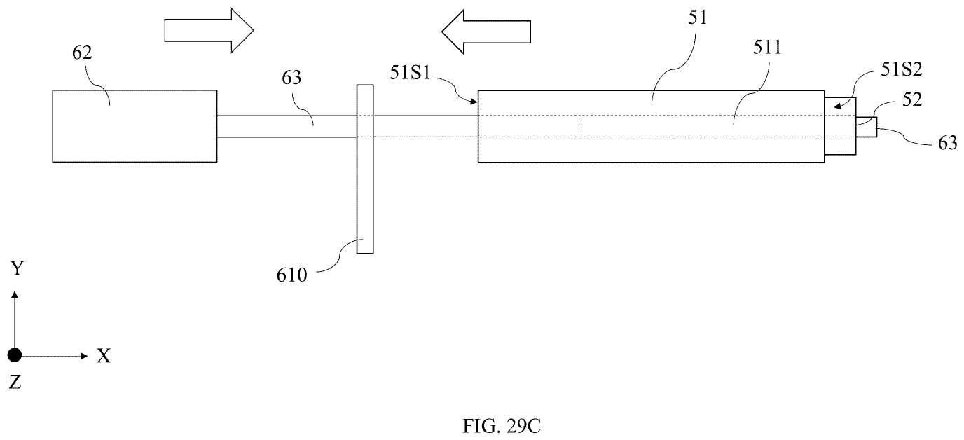

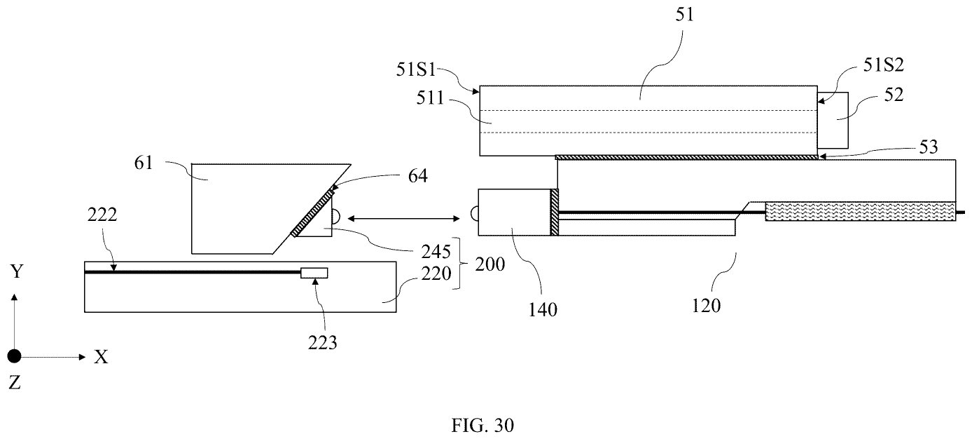

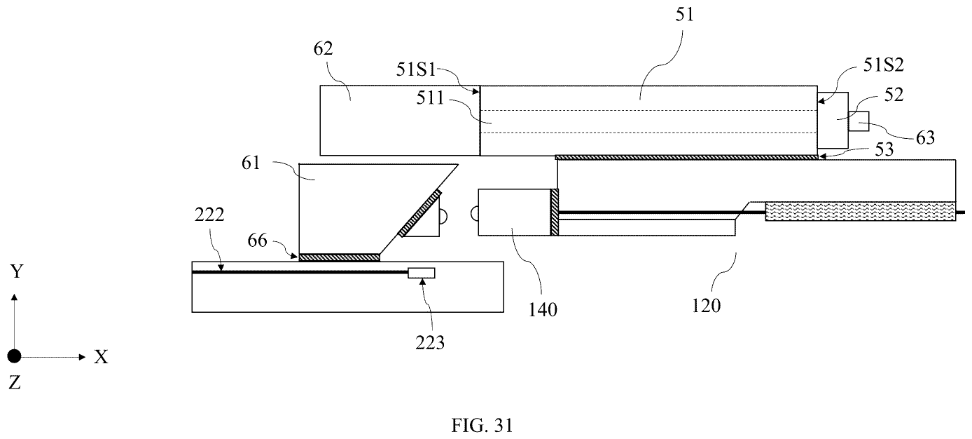

Reference is made to FIG. 28, FIG. 29A, FIG. 29B, FIG. 29C, FIG. 30, and FIG. 31. FIG. 28 to FIG. 31 are schematic diagrams of intermediate stages of a method of forming the optical assembly 7 according to some embodiments of the present disclosure.

In FIG. 28, the fiber array 120 is aligned with the collimator lens array 140 through an active alignment operation. For example, the fibers 124 on the fiber array 120 are connected to the external power meter 601 and the external light source 602 through the external coupler 603. The external light source 602 is configured to generate a test laser beam inputting to the fiber array 120. At the onset of the alignment, the collimator lens array 140 is disposed adjacent to the fiber array 120 along the optical path with a gap therebetween. The collimator lens array 140 couples the test laser beam from the fibers 124 and transmits the same to the reflector 605 at a lower stream of the optical path. The reflector 605 reflects the test laser beam back to the collimator lens array 140, the fibers 124 of the fiber array 120, the external coupler 603, and then enter into the external power meter 601. The power of the reflected test laser beam measured by the external power meter 601 varies during the active alignment operation until an optimal value of the power is reached, and the active alignment between the collimator lens array 140 and the fiber array 120 can be concluded and followed by a fixation operation. The fixation operation includes, but not limited to, solidifying an adhesive material filling the gap between a sidewall of the collimator lens array 140 and a sidewall of the fiber array 120 by performing a curing operation to the adhesive material (e.g., epoxy-based material). It is understandable that prior to solidifying the adhesive material, relative positions of the collimator lens array 140 and the fiber array 120 can be adjusted as needed to obtain the optimal power during active alignment. After solidifying the adhesive material, the collimator array 100 is obtained, as illustrated in FIG. 29A.

Referring to FIG. 29A, the plug housing 62 and the receptacle housing 52 are engaged together with a spot mirror 610 therebetween, and the engaged housings are placed over the collimator array 100 with a gap therebetween. During the process in FIG. 29A, an active alignment is performed using the spot mirror 610, and a position of the receptacle housing 51 over the collimator array 100 is determined. A fixation operation is performed after the position of the receptacle housing 51 is determined and includes, but not limited to, solidifying an adhesive material filling the gap between the plate holder 122 and the receptacle housing 51 by performing a curing operation to the adhesive material (e.g., epoxy-based material). It is understandable that prior to solidifying the adhesive material, relative positions of the plate holder 122 and the receptacle housing 51 can be adjusted as needed. After solidifying the adhesive material, the optical device 50 is obtained, as illustrated in FIG. 30.

Referring to FIG. 29B, the spot mirror 610 includes at least one hole 611 and a plurality of apertures 612. The hole 611 allows the detachable coupling means 63 to pass through. The apertures 612 allow the test laser beam transmitted from the collimator lens array 140 to pass through.

As shown in FIG. 23, when the optical device 50 is engaged with the optical component 60, they are engaged by inserting the detachable coupling means 63 into the pin hole 511, thereby restricting the relative movement, if any, between the optical device 50 and the optical component 60 to be along the axial direction of the detachable coupling means 63 (the X direction as illustrated). Therefore, in some embodiments, the axial direction of the detachable coupling means 63 is set to be the same as the direction of the laser path, which is the same as the axial direction of the fibers 124. However, the plug housing 62 and the receptacle housing 52 may not have additional alignment mechanisms, so alignment is achieved by means of the spot mirror 610 as shown in FIG. 29B.

Specifically, the spot mirror 610 has a flat surface or a surface with acceptable flatness. Prior to performing the alignment shown in FIG. 29A, the detachable coupling means 63 of the plug housing 62 is inserted through the hole 611 of the spot mirror 610 and then into the pin hole 511 of the receptacle housing 51 as shown in FIG. 29C. By aligning the flat surface of the spot mirror 610 with the Y-Z plane, the axial direction of the detachable coupling means 63 is made parallel to the X direction. Because the spot mirror 610 has the flat surface, in the state shown in FIG. 29C, the axial direction of the detachable coupling means 63 is parallel to the axial direction of the fibers 124. Next, the position of the collimator array 100 is adjusted so that the test laser can completely pass through the apertures 612. Without substantive laser beam reflected backward to the external light source 602, the energy detected by the external light source 602 appears to be zero, thereby completing the alignment operation shown in FIG. 29A.

After the receptacle housing 51 is fixated on the plate holder 122, the plug housing 62 is disengaged from the receptacle housing 51, and the spot mirror 610 can be removed.

The number of the hole 611 corresponds to the number of the detachable coupling means 63, and the number of the apertures 612 corresponds to the number of the fibers 124. It should be noted that the quantities of the hole 611 and the apertures 612 are provided for illustrated purposes and are not intended to be limiting.

Referring to FIG. 30, the PIC 200 is aligned with the PIC lens array 245 through an active alignment operation. At the onset of the alignment, the PIC lens is fixated to the support connector 61, and the PIC lens array 245 and the support connector 61 are disposed above the PIC 220 with a gap therebetween. An external test laser beam propagates through the waveguides 222 and enter the PIC lens array 245, the collimator lens array 140, the fiber array 120, and coupled to the external power meter (omitted here). The power of the test laser beam measured by the external power meter varies during the active alignment operation until an optimal value of the power is reached, which may occur when a minimal insertion loss (IL) is found, alignment between the PIC lens array 245 and the PIC 220 can be concluded and followed by a fixation operation. The active alignment set forth can be performed several times for multiple channel pairs between the PIC 220 and the fiber array 120. The fixation operation includes, but not limited to, solidifying an adhesive material filling the gap between the support connector 61 and the PIC 220 by performing a curing operation to the adhesive material (e.g., epoxy-based material). It is understandable that prior to solidifying the adhesive material, relative positions of the PIC lens array 245 and the PIC 220 can be adjusted as needed to obtain the optimal power during active alignment. After solidifying the adhesive material, the PIC array 200 is obtained, as illustrated in FIG. 31.

Referring to FIG. 31, the plug housing 62 is detachably coupled to the receptacle housing 51, and the PIC array 100 is aligned with the plug housing 62 through an active alignment operation. At the onset of the alignment, the plug housing 61 is disposed above the support connector 61 with a gap therebetween. An external test laser beam propagates through the waveguides 222 and enter the PIC lens array 245, the collimator lens array 140, the fiber array 120, and coupled to the external power meter (omitted here). The power of the test laser beam measured by the external power meter varies during the active alignment operation until an optimal value of the power is reached, which may occur when a minimal insertion loss is found, alignment between the PIC array 220 and the plug housing 62 can be concluded and followed by a fixation operation. The fixation operation includes, but not limited to, solidifying an adhesive material 65 (shown in FIG. 23) filling the gap between the support connector 61 and the plug housing 62 by performing a curing operation to the adhesive material (e.g., epoxy-based material). It is understandable that prior to solidifying the adhesive material, relative positions of the PIC array 200 and the plug housing 62 can be adjusted as needed to obtain the optimal power during active alignment. After solidifying the adhesive material, the optical assembly 7 is obtained, as illustrated in FIG. 23.

In some embodiments, the method of forming the optical assembly further includes disengaging the receptacle housing 51 from the plug housing 62 after the plug housing is fixated to the PIC array 200 and forming the optical assembly further includes fixating the handler 52 to the collimator array 100.

In respect to methods of forming the optical assembly 8 of FIG. 26 can be referred to the description associated with FIG. 28, FIG. 29, FIG. 30, and FIG. 31, and are not repeated here for brevity.

Some embodiments of the present disclosure provide an optical device including a collimator array, a receptacle housing, and an anti-slip collar. The collimator array includes a fiber array and a collimator lens array. The fiber array includes fibers and a plate holder carrying the fibers. The collimator lens array is fixated to the fiber array by a first adhesive and optically coupled to the fibers. The receptacle housing is fixated to the collimator array in part by a second adhesive, and includes a pin hole running through the receptacle housing from a first side surface to a second side surface opposite to the first side surface. The pin hole is configured to receive a detachable coupling means of a corresponding plug housing external to the optical device, so as to mechanically couple the plug housing to the receptacle housing. The anti-slip collar is attached at the second side surface of the receptacle housing and configured to accommodate the detachable coupling means and provide a friction to the detachable coupling means.

Some embodiments of the present disclosure provide an optical device including a collimator array and a plug housing. The collimator array includes a fiber array and a collimator lens array. The fiber array includes fibers and a plate holder carrying the fibers. The collimator lens array is fixated to the fiber array by a first adhesive and optically coupled to the fibers. The plug housing is fixated to the collimator array in part by a second adhesive, and includes a detachable coupling means protruding from a side surface of the plug housing and running in parallel to an axial direction of the fibers. The detachable coupling means is configured for inserting into a pin hole of a corresponding receptacle housing external to the optical device, so as to mechanically couple the plug housing to the receptacle housing.

Some embodiments of the present disclosure provide a method of forming an optical assembly. The method includes: performing a first active alignment between a collimator lens array and a fiber array attaching the collimator lens array to the fiber array so as to form a collimator array; attaching a receptacle housing on the collimator array; performing a second active alignment between a PIC lens array and a PIC having a plurality of waveguides; attaching the PIC lens array to the PIC so as to form a PIC array; and performing a third active alignment between the collimator array and the PIC array and attaching the plug housing to the PIC array accordingly.

The foregoing outlines features of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An optical device, comprising:
a collimator array, comprising:
a fiber array, comprising:
a plurality of fibers; and
a plate holder carrying the plurality of fibers; and
a collimator lens array fixated to the fiber array by a first adhesive, and optically coupled to the plurality of fibers;
a receptacle housing fixated to the collimator array in part by a second adhesive, comprising:
a pin hole running through the receptacle housing from a first side surface to a second side surface opposite to the first side surface, configured to receive a detachable coupling means of a corresponding plug housing external to the optical device, so as to mechanically couple the plug housing to the receptacle housing;
an anti-slip collar attached at the second side surface of the receptacle housing, configured to accommodate the detachable coupling means and provide a friction to the detachable coupling means.

2. The optical device of claim 1, wherein the anti-slip collar is composed of elastomeric material.

3. The optical device of claim 1, wherein the anti-slip collar comprises a first portion having a first inner diameter and a second portion having a second inner diameter, wherein the first inner diameter is substantially equal to a diameter of the detachable coupling means, and the second inner diameter is smaller than the diameter of the detachable coupling means.

4. The optical device of claim 1, wherein the plurality of fibers are disposed on a first surface of the plate holder, wherein the fiber array further comprises:
a lid covering the plate holder from the first surface.

5. The optical device of claim 4, wherein a second surface of the plate holder is attached to the receptacle housing by the second adhesive, wherein the second surface of the plate holder is opposite to the first surface of the plate holder.

6. The optical device of claim 5, further comprising:
a handler fixated to the collimator array, having a gripping area configured for a user to hold.

7. The optical device of claim 4, wherein the receptacle housing is attached to the lid by the second adhesive.

8. The optical device of claim 1, wherein the detachable coupling means runs through the receptacle housing via the pin hole and is in contact with the anti-slip collar at one end of the detachable coupling means.

9. An optical assembly, comprising:
an optical device of claim 1;
a photonic integrated circuit (PIC) array, comprising:
a PIC having a plurality of waveguides;
a support connector fixated to the PIC by a third adhesive; and
a PIC lens array fixated to the support connector by a fourth adhesive, and optically coupled to the plurality of waveguides; and
a plug housing fixated to the PIC array by a fifth adhesive, comprising:
the detachable coupling means protruding from a side surface of the plug housing and running parallel to an axial direction of the plurality of waveguides.

10. An optical device, comprising:
a collimator array, comprising:
a fiber array, comprising:
a plurality of fibers; and
a plate holder carrying the plurality of fibers; and
a collimator lens array fixated to the fiber array by a first adhesive, and optically coupled to the plurality of fibers; and
a plug housing fixated to the collimator array in part by a second adhesive, comprising:
a detachable coupling means protruding from a side surface of the plug housing and running in parallel to an axial direction of the plurality of fibers, configured for inserting into a pin hole of a corresponding receptacle housing external to the optical device, so as to mechanically couple the plug housing to the receptacle housing.

11. The optical device of claim 10, wherein the plurality of fibers are disposed on a first surface of the plate holder, wherein the fiber array further comprises:
a lid covering the plate holder from the first surface.

12. The optical device of claim 11, wherein a second surface of the plate holder is attached to the plug housing by the second adhesive, wherein the second surface of the plate holder is opposite to the first surface of the plate holder.

13. The optical device of claim 12, further comprising:
a handler fixated to the collimator array, having a gripping area configured for a user to hold.

14. The optical device of claim 11, wherein the receptacle housing is attached to the lid by the second adhesive.

15. An optical system, comprising:
an optical device of claim 10;
a photonic integrated circuit (PIC) array, comprising:
a PIC having a plurality of waveguides;
a support connector fixated to the PIC by a third adhesive; and
a PIC lens array fixated to the support connector by a fourth adhesive, and optically coupled to the plurality of waveguides;
a receptacle housing fixated to the PIC array by a fifth adhesive, comprising:
a pin hole running through the receptacle housing from a first side surface to a second side surface opposite to the first side surface, configured to receive the detachable coupling means of the plug housing of the optical device, so as to mechanically couple the plug housing to the receptacle housing; and
an anti-slip collar at the second surface of the receptacle housing, configured to accommodate the detachable coupling means and provide a friction to the detachable coupling means.

16. A method of forming an optical assembly, comprising:
performing a first active alignment between a collimator lens array and a fiber array
attaching the collimator lens array to the fiber array so as to form a collimator array;
attaching a receptacle housing on the collimator array;
performing a second active alignment between a photonic integrated circuit (PIC) lens array and a PIC having a plurality of waveguides;
attaching the PIC lens array to the PIC so as to form a PIC array; and
performing a third active alignment between the collimator array and the PIC array.

17. The method of claim 16, wherein performing the attaching the collimator lens array to the fiber array accordingly comprises:
prior to performing the first active alignment, applying a first adhesive material in a gap between the collimator lens array and the fiber array; and
after performing the first active alignment, solidifying the first adhesive material.

18. The method of claim 16, wherein attaching the receptacle housing on the collimator array comprises:
performing a fourth active alignment using a spot mirror, causing an axial direction of the fiber array substantially parallel to an axial direction of a detachable coupling means correspondingly engaged with the receptacle housing with the spot mirror spacing therebetween;
prior to the fourth active alignment, applying a second adhesive material between the receptacle housing and the fiber array; and
after the fourth active alignment, solidifying the second adhesive material.

19. The method of claim 16, wherein attaching the PIC lens array to the PIC accordingly comprises:
prior to performing the second active alignment, applying a third adhesive material in a gap between the PIC lens array and the PIC; and
after performing the second active alignment, solidifying the third adhesive material.

20. The method of claim 16, further comprising:
prior to attaching the receptacle housing on the collimator array, inserting a pin protruding from a side of the plug housing facing the receptacle housing into a corresponding pin hole and a corresponding anti-slip collar of the receptacle housing.

21. The method of claim 16, further comprising:
fixating a handler to the collimator array for providing a gripping area for a user to hold.

22. The method of claim 18, further comprises:
after attaching the receptacle housing to the collimator array, disengaging the plug housing from the receptacle housing.

23. The method of claim 16, further comprising:
prior to performing the third active alignment, applying a fourth adhesive material in a gap between the PIC lens array and the plug housing; and
after performing the third active alignment, solidifying the fourth adhesive material.
